(19) United States
(12) Patent Application Publication
(10) Pub. No.: US 2014/0337136 A1
(43) Pub. Date: Nov. 13, 2014

(54) AD SCHEDULING

(71) Applicant: OpenTV, Inc., San Francisco, CA (US)

(72) Inventor: John Tinsman, Fallbrook, CA (US)

(73) Assignee: OpenTV, Inc., San Francisco, CA (US)

(21) Appl. No.: 14/276,821

(22) Filed: May 13, 2014

Related U.S. Application Data
(60) Provisional application No. 61/822,833, filed on May 13, 2013.

(51) Int. Cl. G06Q 30/02

(52) U.S. Cl. CPC G06Q 30/0264; G06Q 30/0261
USPC 705/14.58; 705/14.61

(57) ABSTRACT

An advertisement scheduling machine may be configured to facilitate scheduling of one or more advertisements. As configured, the advertisement scheduling machine may cause presentation of a graphical user interface that displays multiple timeslots available for scheduling advertisements. The advertisement scheduling machine detects that an advertisement has been selected from multiple advertisements available for scheduling, and the selected advertisement may be unscheduled in any of the displayed timeslots. The advertisement scheduling machine accesses a scheduling rule associated with the selected advertisement and determines that the selected advertisement is schedulable in only a portion of the displayed timeslots and not a remainder of them, in accordance with the scheduling rule. The advertisement scheduling machine then causes the graphical user interface to indicate that the selected advertisement is schedulable in only the portion of the timeslots but not in the remainder.

### PRIORITY

This patent application claims the benefit of priority to U.S. Provisional Patent Application Ser. No. 61/822,833, filed on May 13, 2013, which is incorporated herein by reference in its entirety.

### TECHNICAL FIELD

The subject matter disclosed herein generally relates to the processing of data. Specifically, the present disclosure addresses systems and methods to facilitate scheduling of advertisements (“ads”).

### BACKGROUND

A media server system (e.g., with one or more server machines) may be configured to provide various media content (e.g., media programs such as video programs, audio programs, or interactive multimedia programs) and various advertisements. Such media content and advertisers may be provided to one or more users (e.g., viewers or consumers) and via one or more networks. Media content and advertisements may be organized into channels (e.g., media channels, such as television channels or Internet media channels), and the media server system may offer multiple channels for selection by the users. In some situations, media content (e.g., a movie, a show, or a sports event) and an advertisement may be scheduled into adjacent (e.g., sequential) timeslots within a channel. In certain situations, portions of the media content (e.g., 20 minute segments) may be scheduled within the channel, with one or more advertisements scheduled in between any two sequential portions of the media content.

### BRIEF DESCRIPTION OF THE DRAWINGS

Some embodiments are illustrated by way of example and not limitation in the figures of the accompanying drawings.

FIG. 1 is a network diagram illustrating a network environment suitable for scheduling one or more ads, according to some example embodiments.

FIGS. 2-27 are slides that collectively illustrate and discuss example embodiments of various screens that are presentable as part of a graphical user interface provided by the ad scheduling machine, according to some example embodiments.

FIGS. 28-30 are flowcharts illustrating operations of the ad scheduling machine in performing a method of scheduling an ad, according to some example embodiments.

FIG. 31 is a block diagram illustrating components of a machine, according to some example embodiments, able to read instructions from a machine-readable medium and perform any one or more of the methodologies discussed herein.

### DETAILED DESCRIPTION

Example methods and systems are directed to scheduling advertisements (“ads”). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A system (e.g., a computer system) in the example form of a machine having one or more processors may be configured (e.g., by one or more software modules) to perform one or more of the operations discussed herein. Various subsets of the operations discussed herein may constitute example embodiments of a method for scheduling ads. In particular example embodiments, the system is configured to present a graphical user interface to a user (e.g., an ad scheduler) of the system. Such a graphical user interface may include one or more screens (e.g., graphical windows that are shown on a display device that is fully or partially controlled by the system) for interacting with the system and performing tasks that facilitate the scheduling of ads. Example embodiments of such screens are illustrated in the figures that form a part of this document.

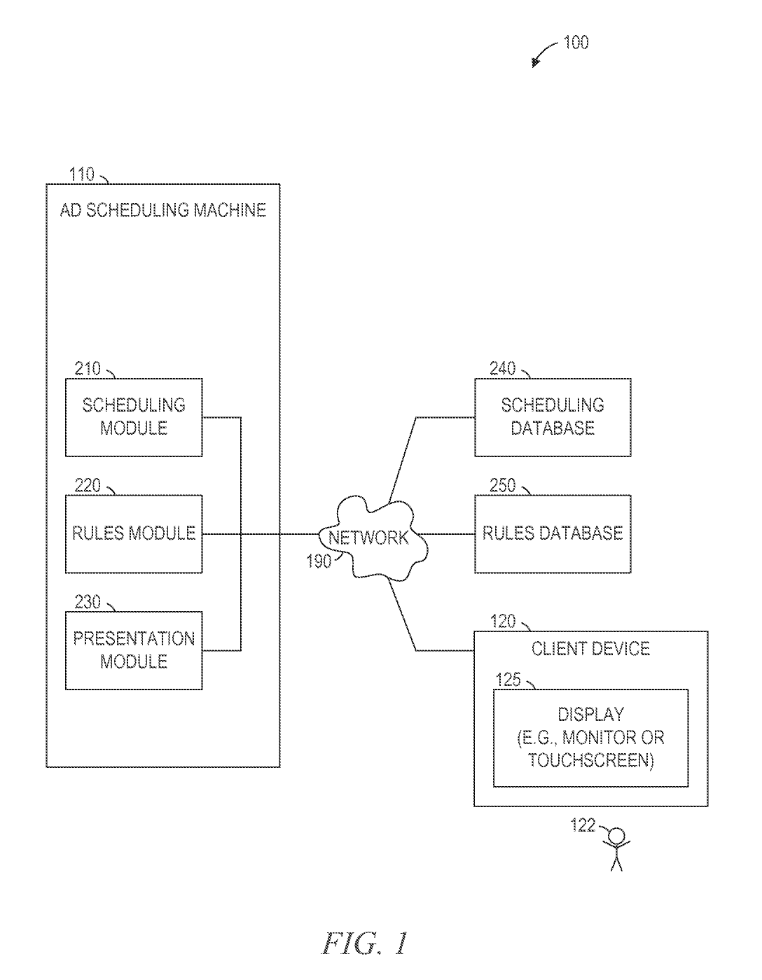

FIG. 1 is a network diagram illustrating a network environment 100 suitable for scheduling an ad, according to some example embodiments. The network environment 100 includes an ad scheduling machine 110, a scheduling database 240, a rules database 250, and a client device 120, all communicatively coupled to each other via a network 190.

The ad scheduling machine 110, the client device 120, or any suitable combination thereof, may cause one or more screens (e.g., graphical windows) to be presented to the user 122 (e.g., on a computer monitor, a mobile device, or other display device) and enable the user 122 to schedule an ad by interacting with the ad scheduling machine 110. For example, as shown in FIG. 1, the ad scheduling machine 110 may include a scheduling module 210 configured to manage the scheduling database 240, which may maintain a schedule (e.g., a programming schedule or programming grid) for ads (e.g., among other media programs to be broadcast from a broadcast server machine); a rules module 220 configured to access the rules database 250, which may store rules governing individual ads (e.g., rules set by a customer for presenting an ad); and a presentation module 230 configured to generate and present one or more screens of a graphical user interface to the user 122 for interaction. For example, the presentation module 230 may present one or more screens on a display 125 of the client device 120, which may be communicatively coupled to the ad scheduling machine 110 (e.g., by the network 190).

The scheduling module 210, the rules module 220, and the presentation module 230 may be configured to communicate with each other (e.g., by a bus, a shared memory, or a switch). Any one or more of these modules may be implemented in hardware (e.g., a processor of the machine) or in a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The presentation of one or more screens (e.g., graphical windows) of the graphical user interface may form all or part of a technical solution to a technical problem. For example, a technical problem may be or include an inability to use existing systems (e.g., existing ad scheduling system) in a manner that simplifies key user workflows, increases user productivity, implements a “push” model for scheduling rules (e.g., business rules) that govern the scheduling of an ad (e.g., instead of a “pull” model for such rules), reduces the number of clicks used to complete the tasks, provides status information on key processes (e.g., previously requested processes that are currently executing), or any suitable combination thereof. A technical solution to such a technical problem may be provided by the ad scheduling machine 110, for example, in presenting one or more of the screens described herein to the user for interaction. One or more of these screens may increase user productivity, for example, by simplifying key user workflows, reducing the complexity of steps used to complete various tasks, allowing users to schedule (e.g., place) ads quickly, or any suitable combination thereof. Such quick (e.g., accelerated or enhanced) ad scheduling may be enabled by combining the scheduling module 210, the rules module 220, and the presentation module 230, such that, in various example embodiments, only timeslots that comport with (e.g., satisfy) all scheduling rules for a given ad are available for scheduling that ad. This technical solution may be absent from existing ad scheduler systems that have slow user productivity (e.g., as a result of lengthy user workflows, complicated task completion processes, or both).

The client device 120 may be configured to enable the user 122 to interact with the ad scheduling machine 110. The ad scheduling machine 110, the client device 120, the scheduling database 240, the rules database 250, or any suitable combination thereof, may be implemented in a machine (e.g., computer system) as described below with respect to FIG. 33.

The user 122 may be a human user (e.g., a human being), a machine user (e.g., a computer configured by a software program to interact with the client device 120), or any suitable combination thereof (e.g., a human assisted by a machine or a machine supervised by a human). The user 122 is not part of the network environment 100, but is associated with the client device 120 and may be a user of the client device 120. For example, the client device 120 may be a desktop computer, a vehicle computer, a tablet computer, a navigational device, a portable media device, a smartphone, or a wearable device (e.g., a smart watch or smart glasses) belonging to the user 122.

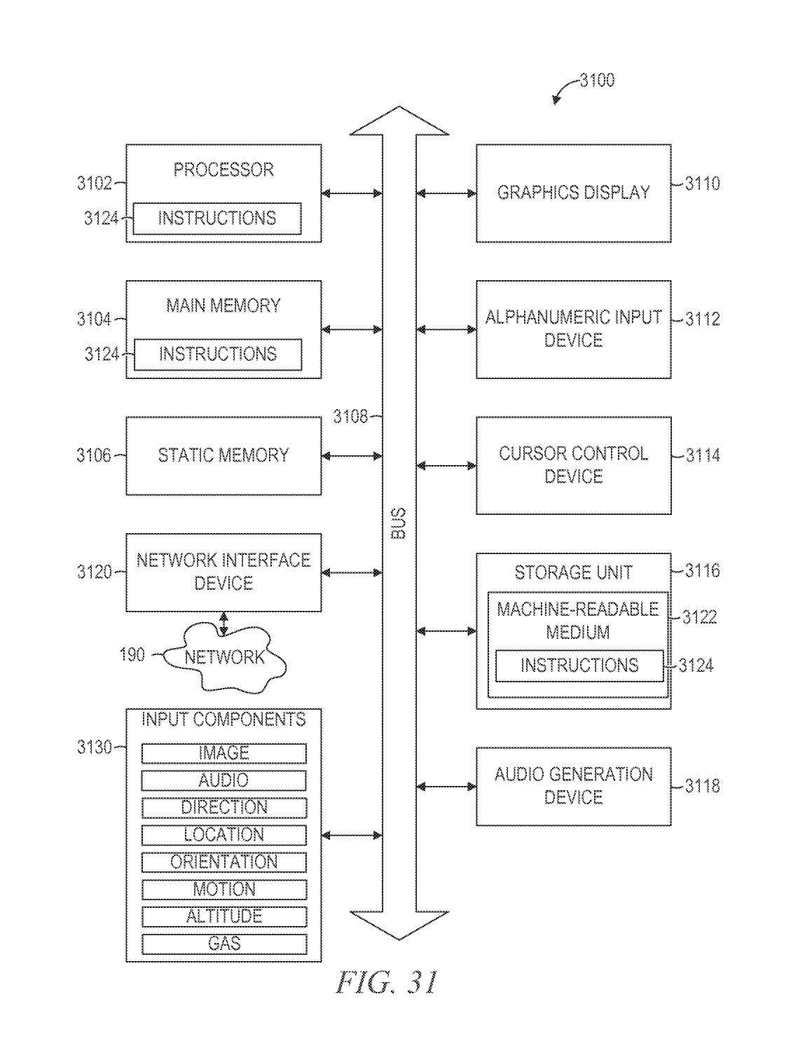

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 31. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the ad scheduling machine 110 and the client device 120). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

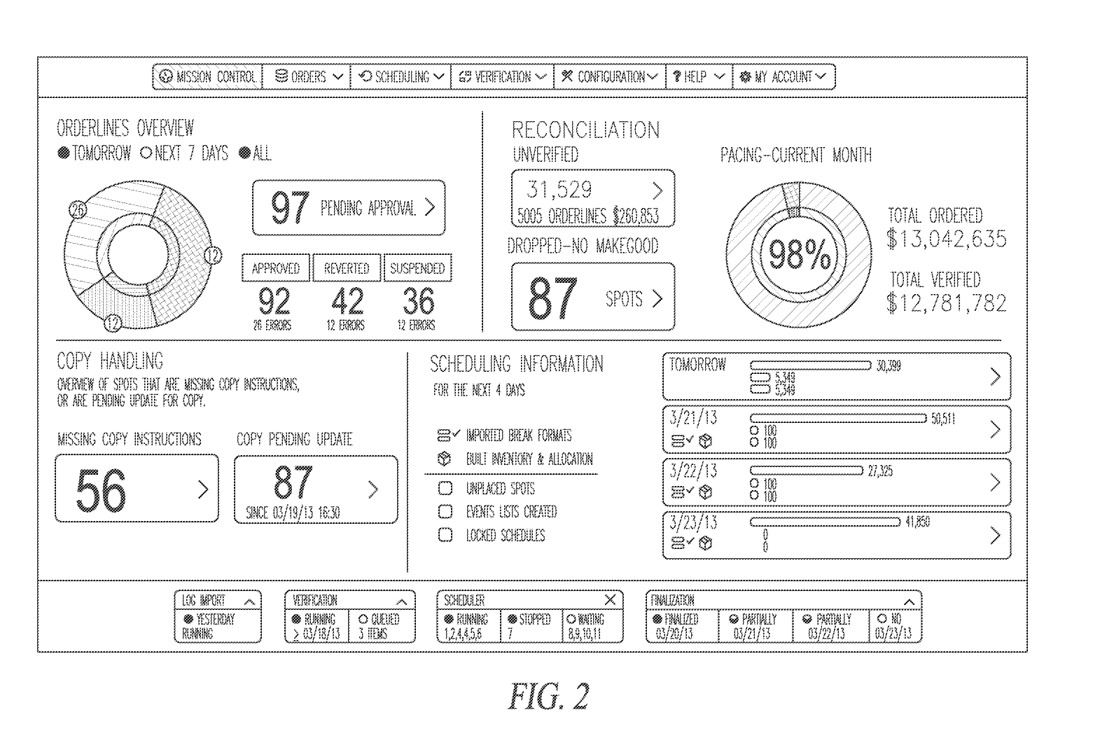

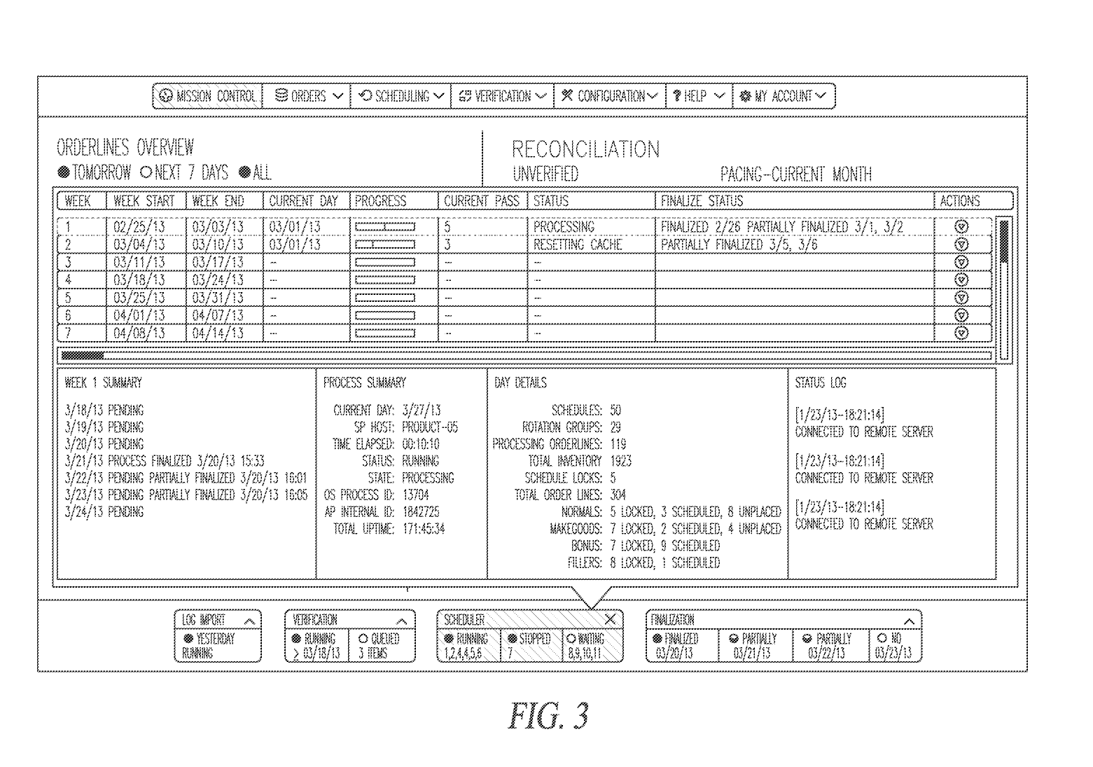

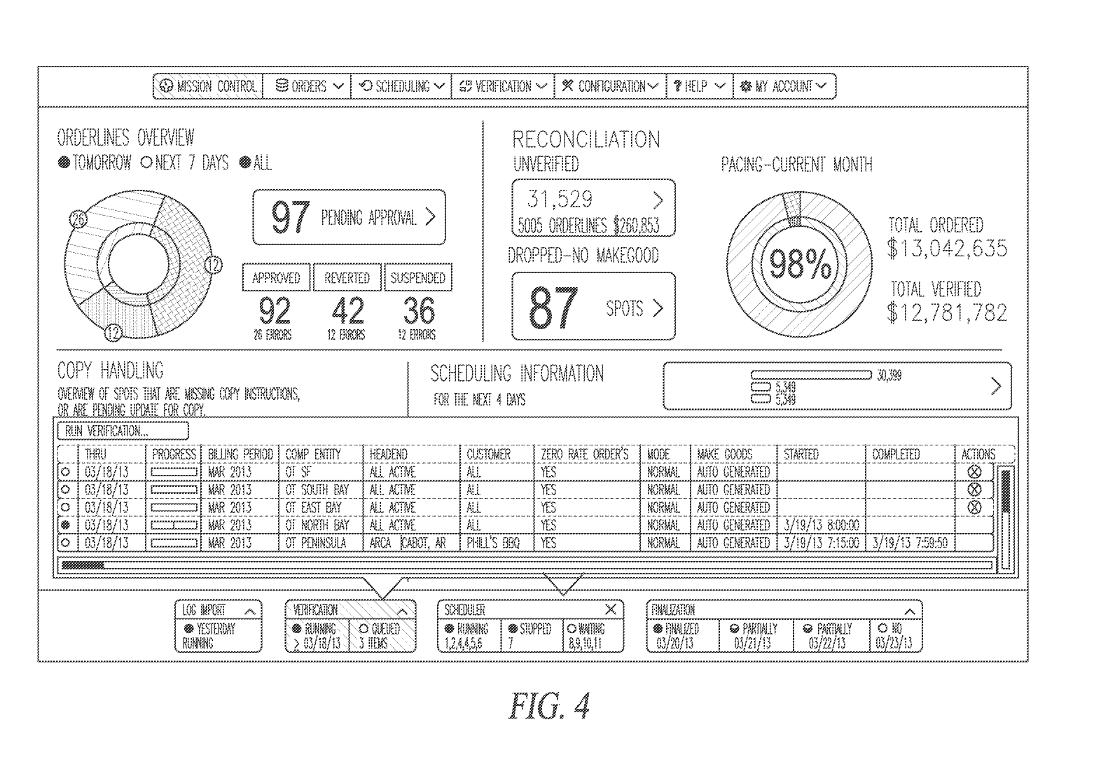

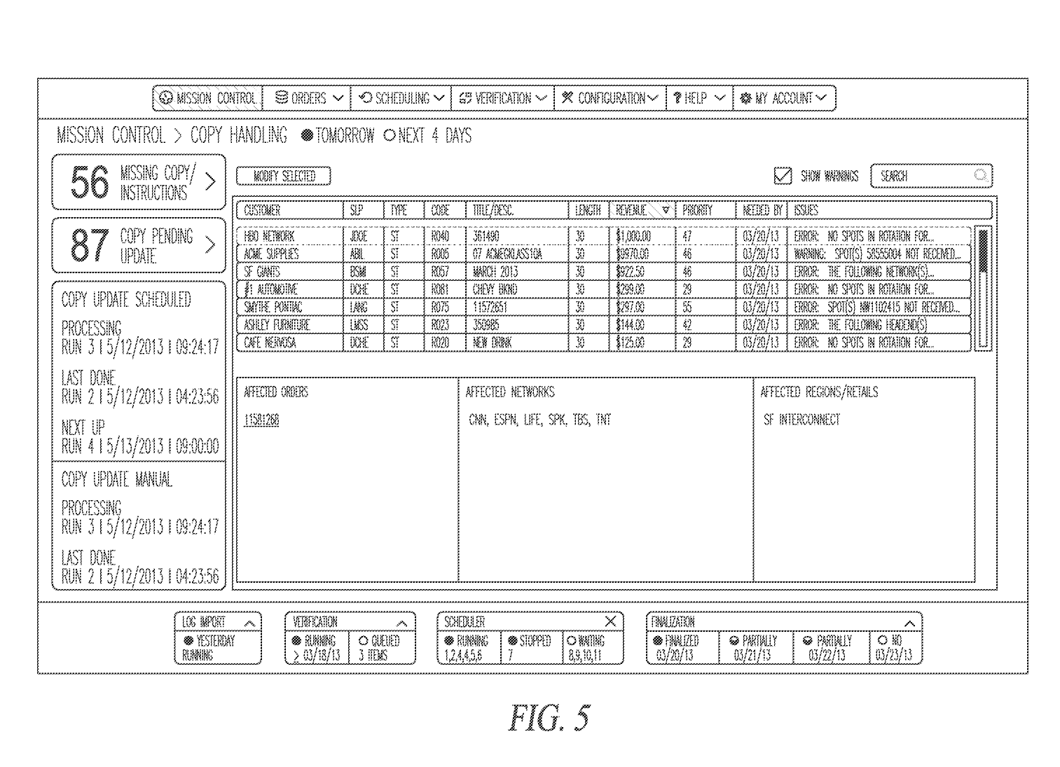

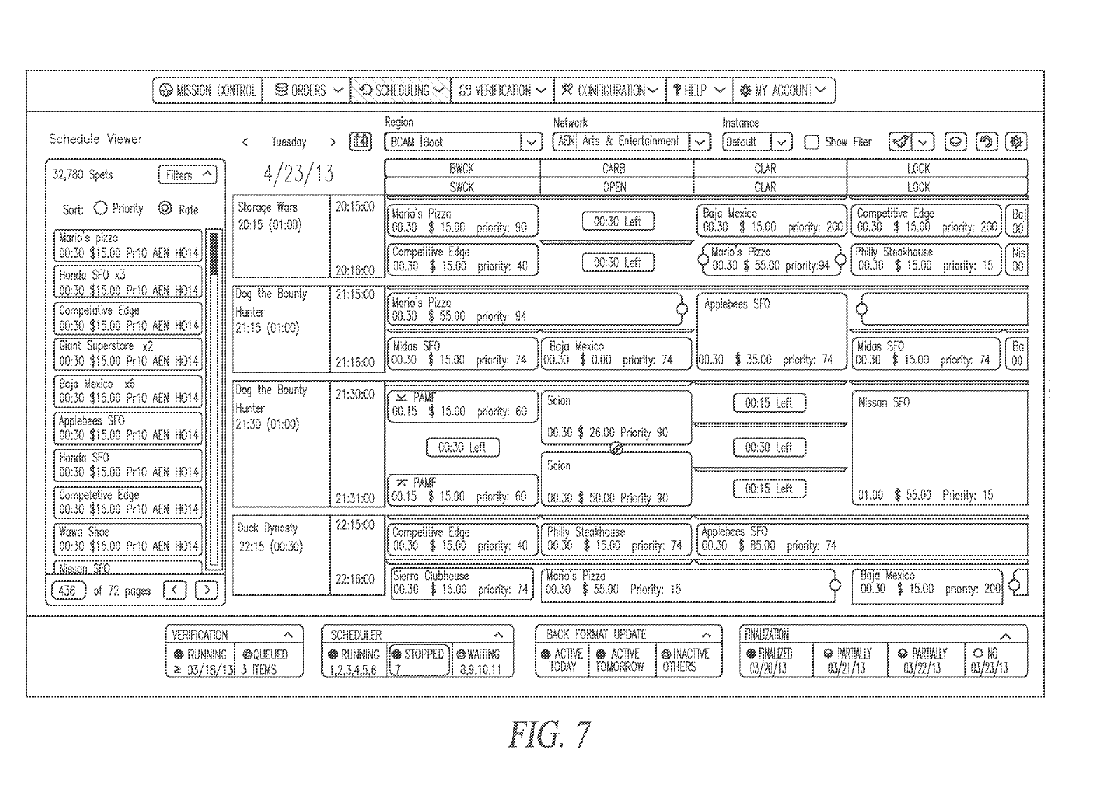

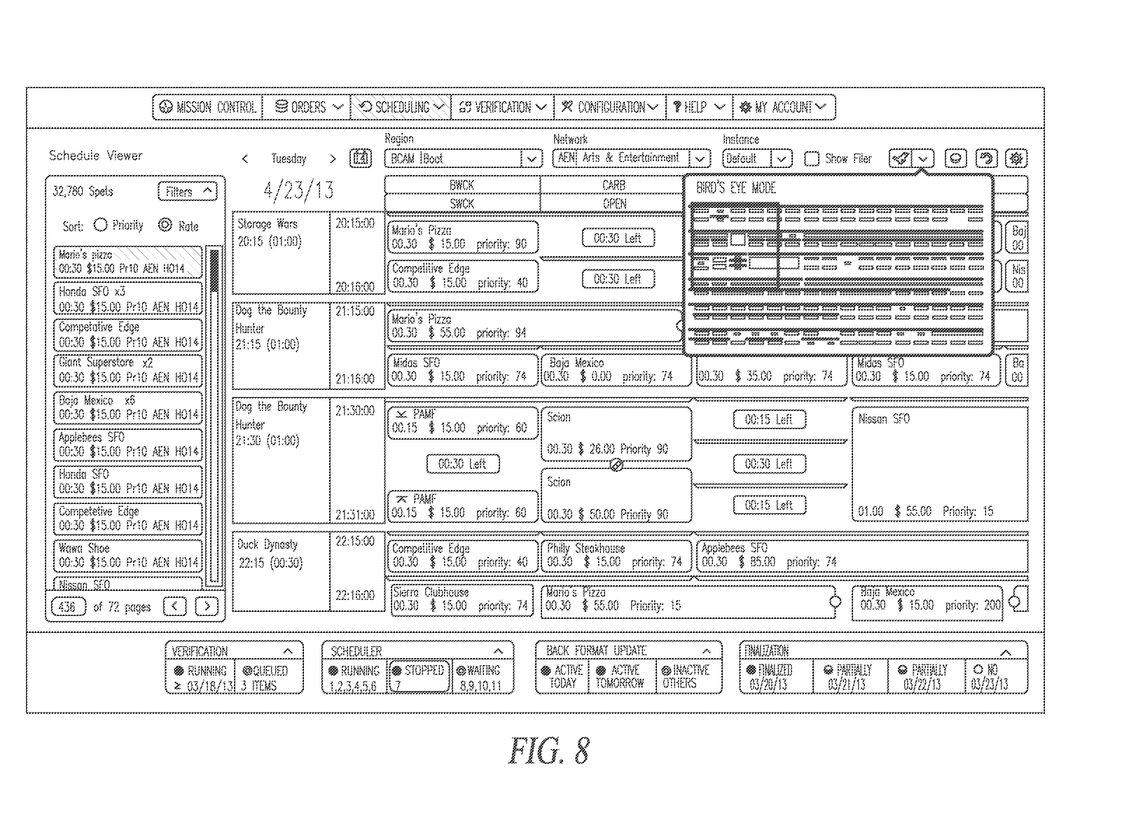

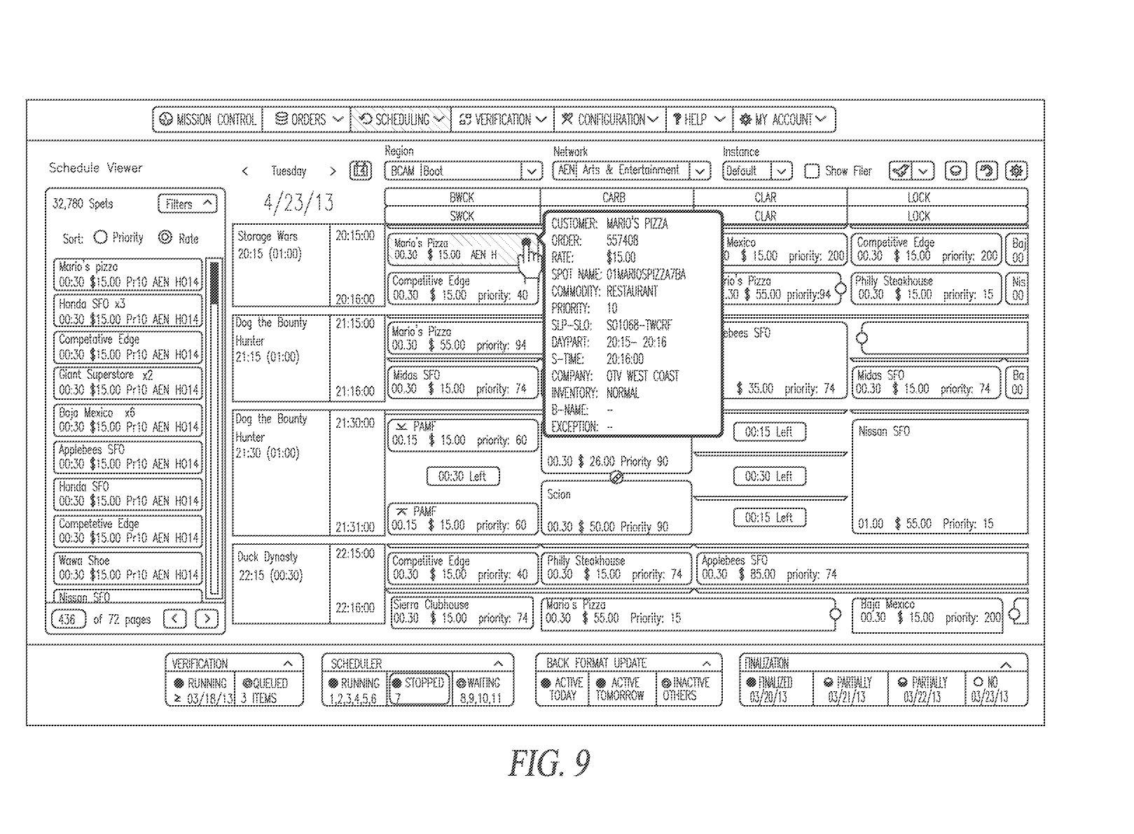

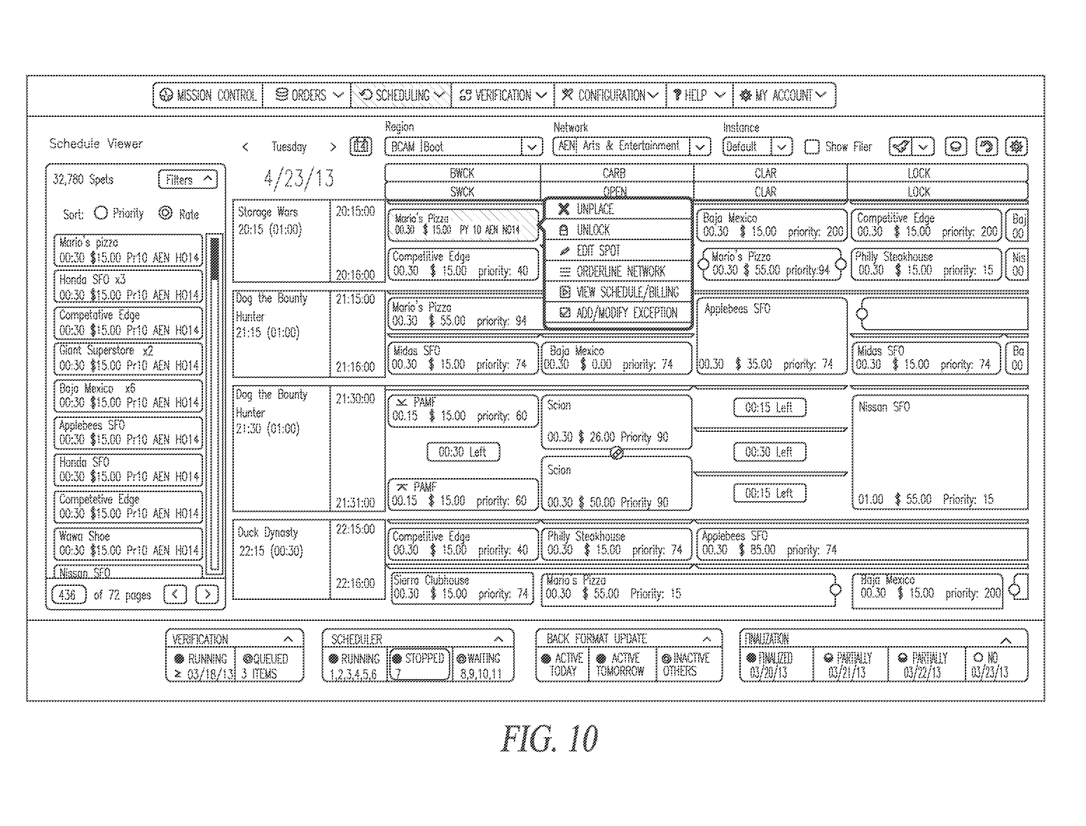

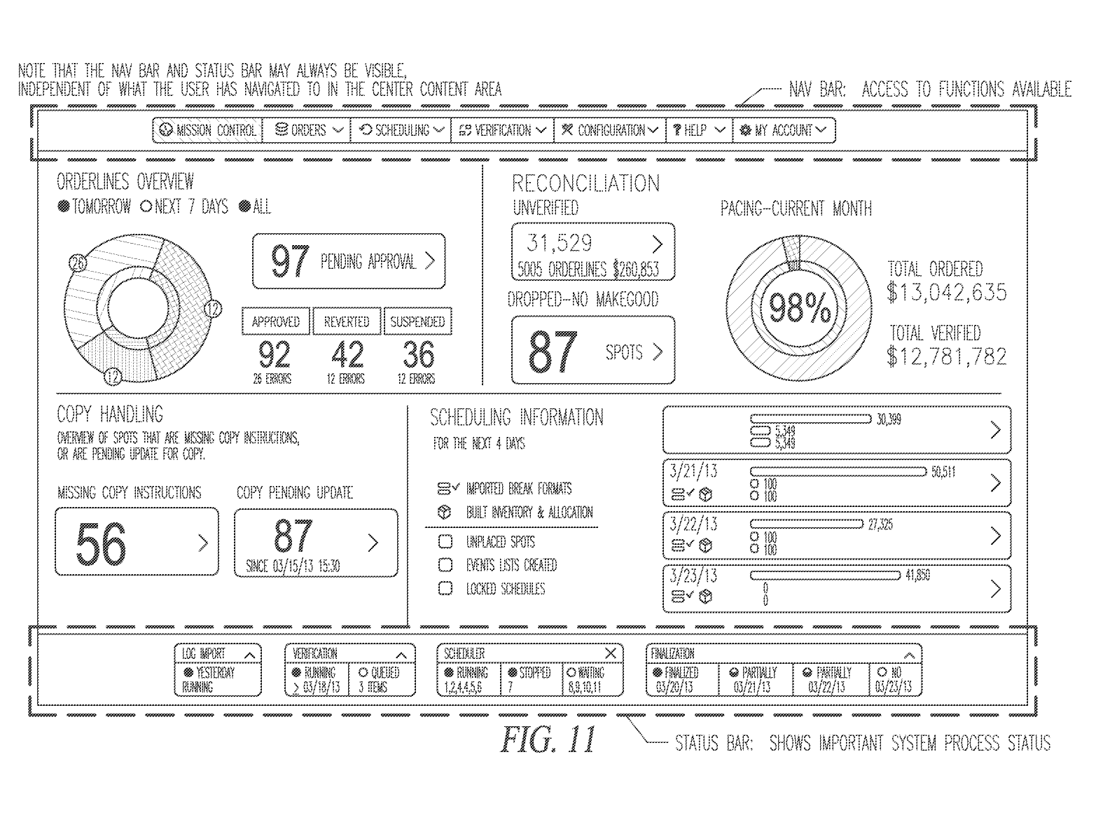

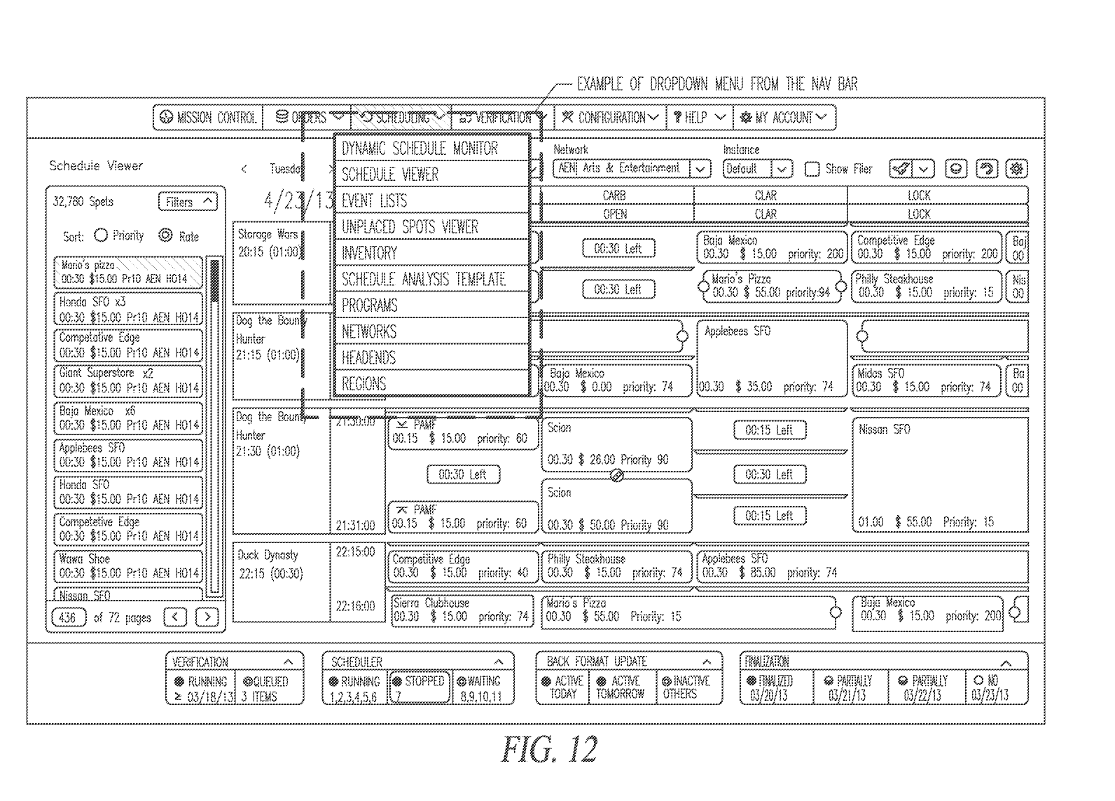

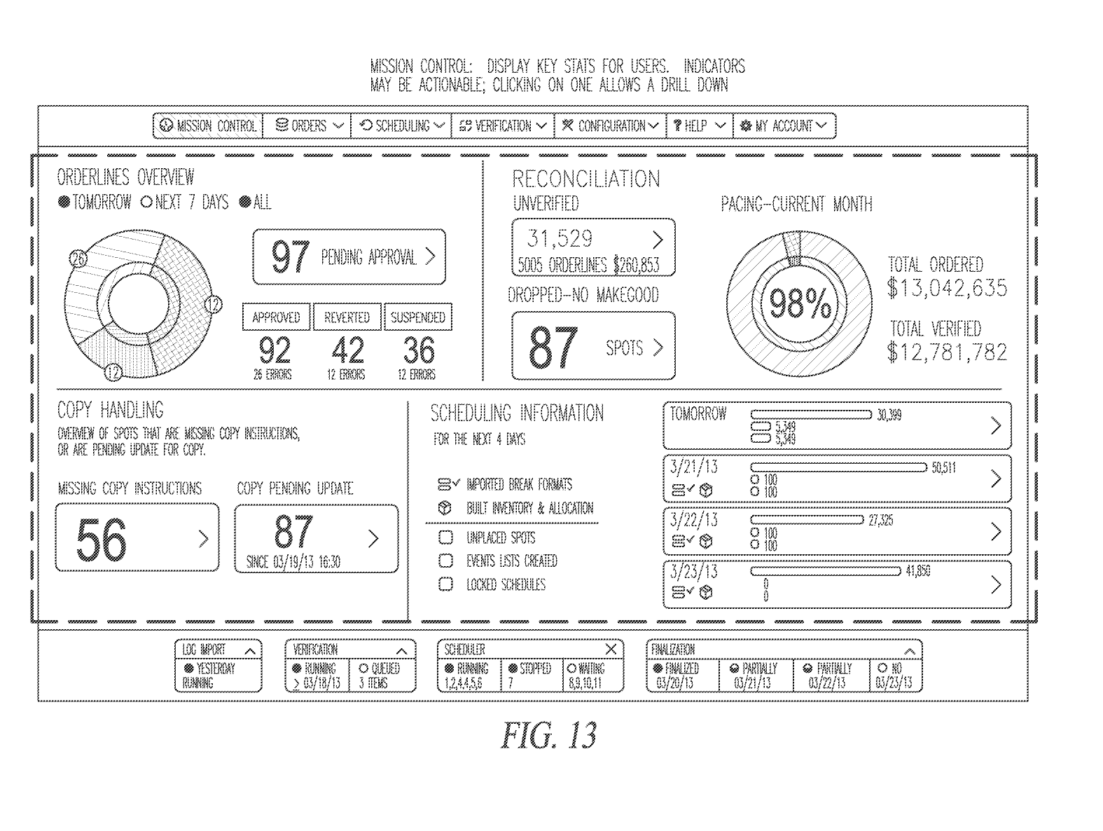

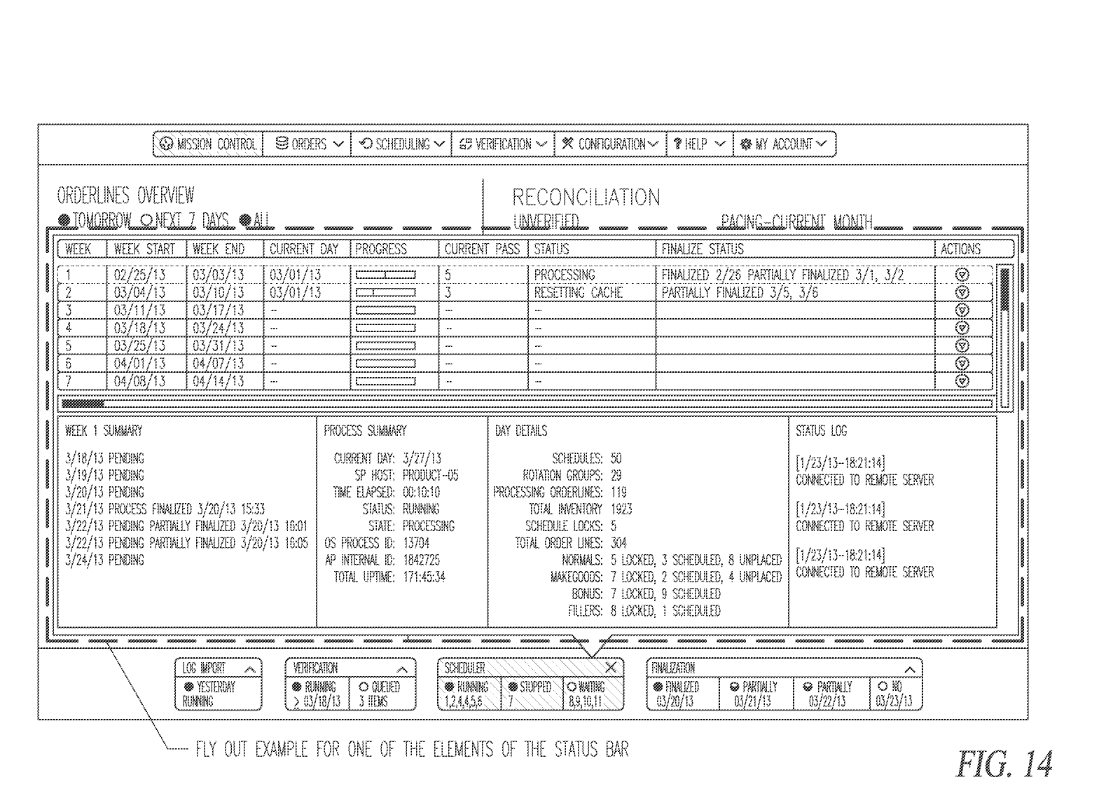

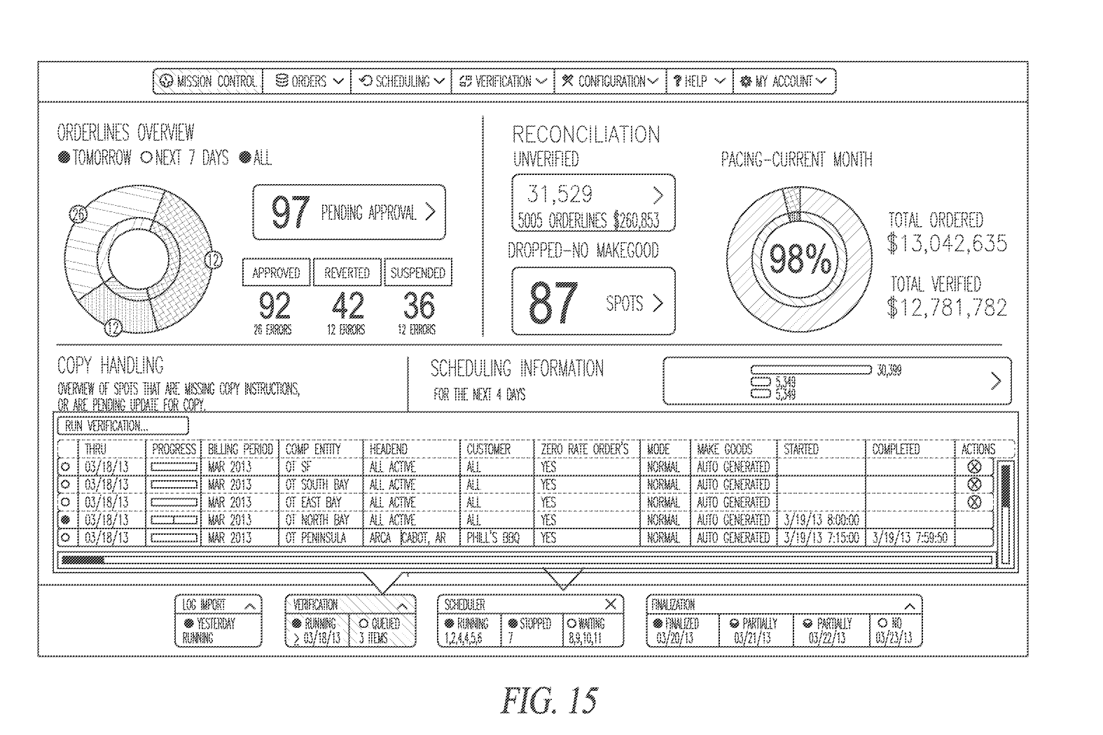

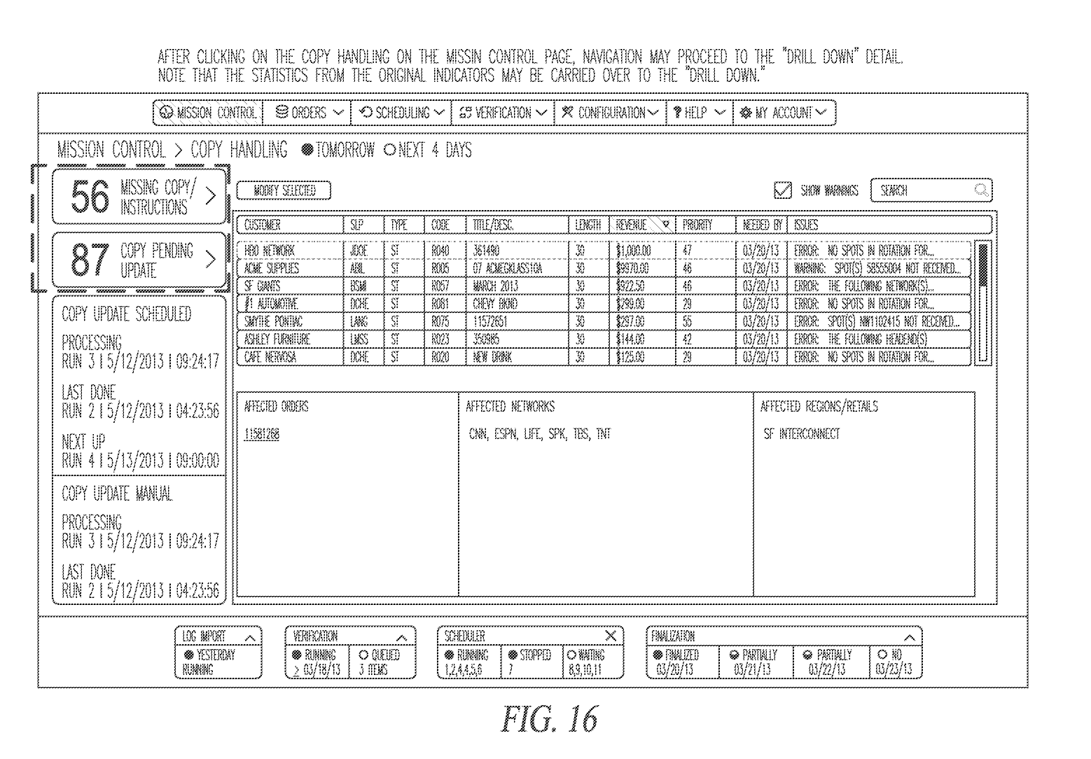

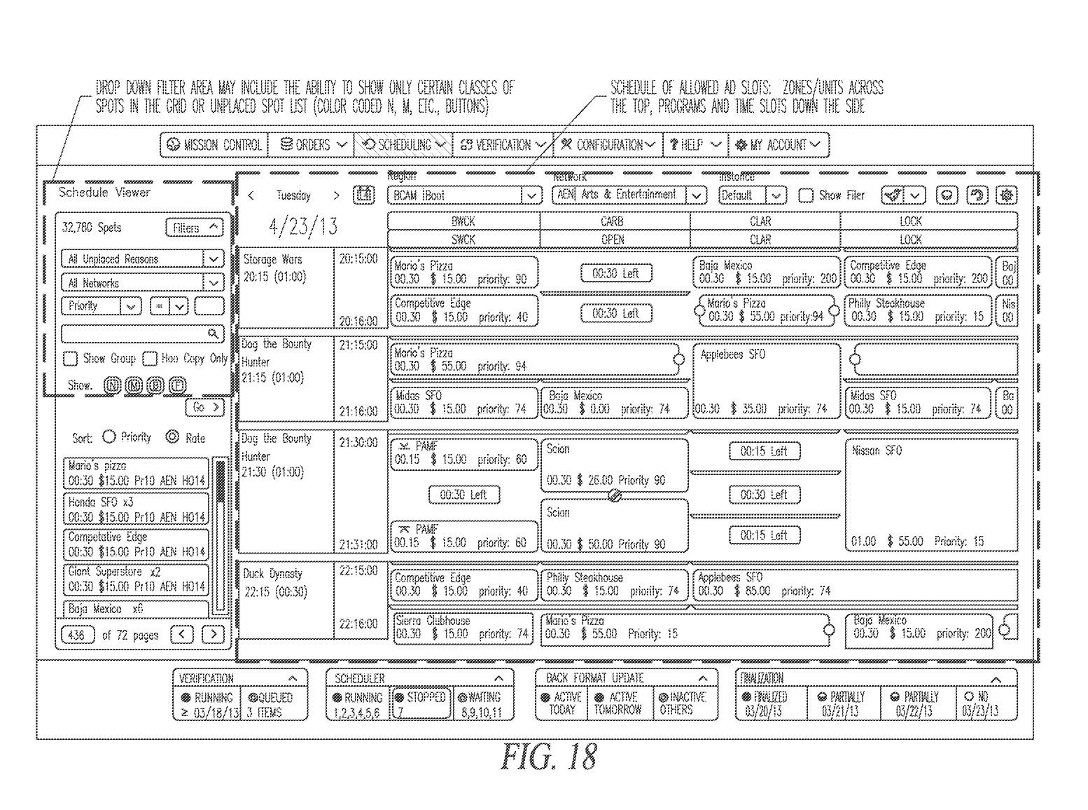

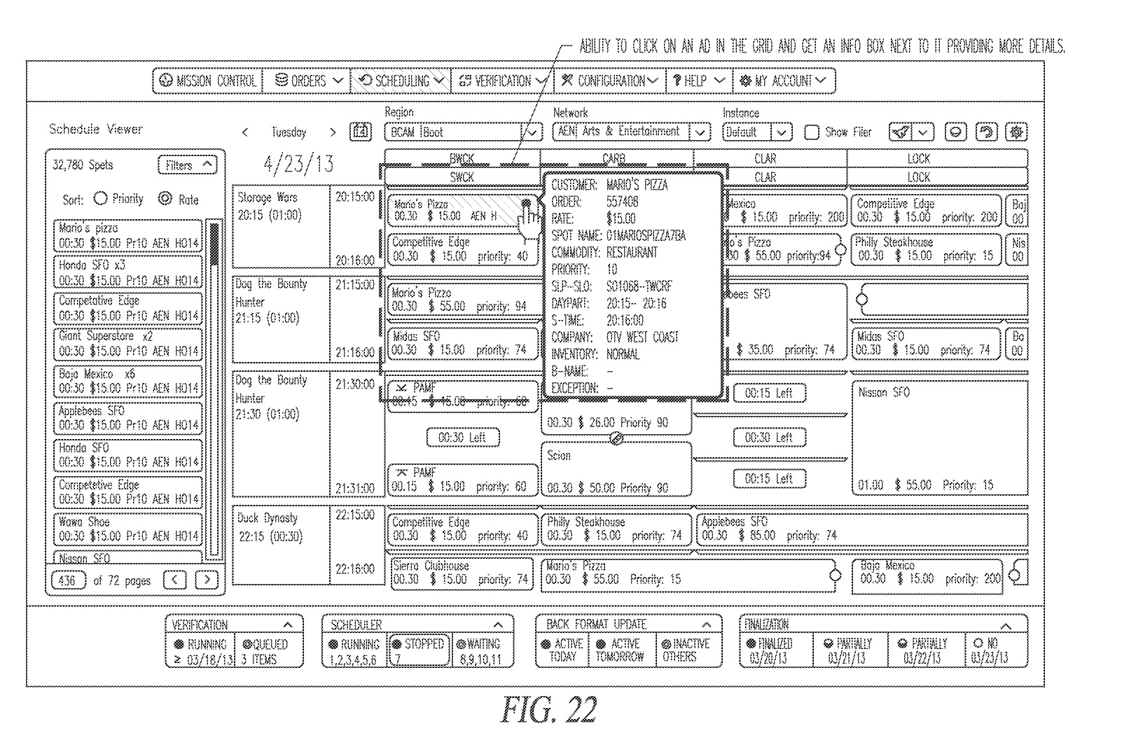

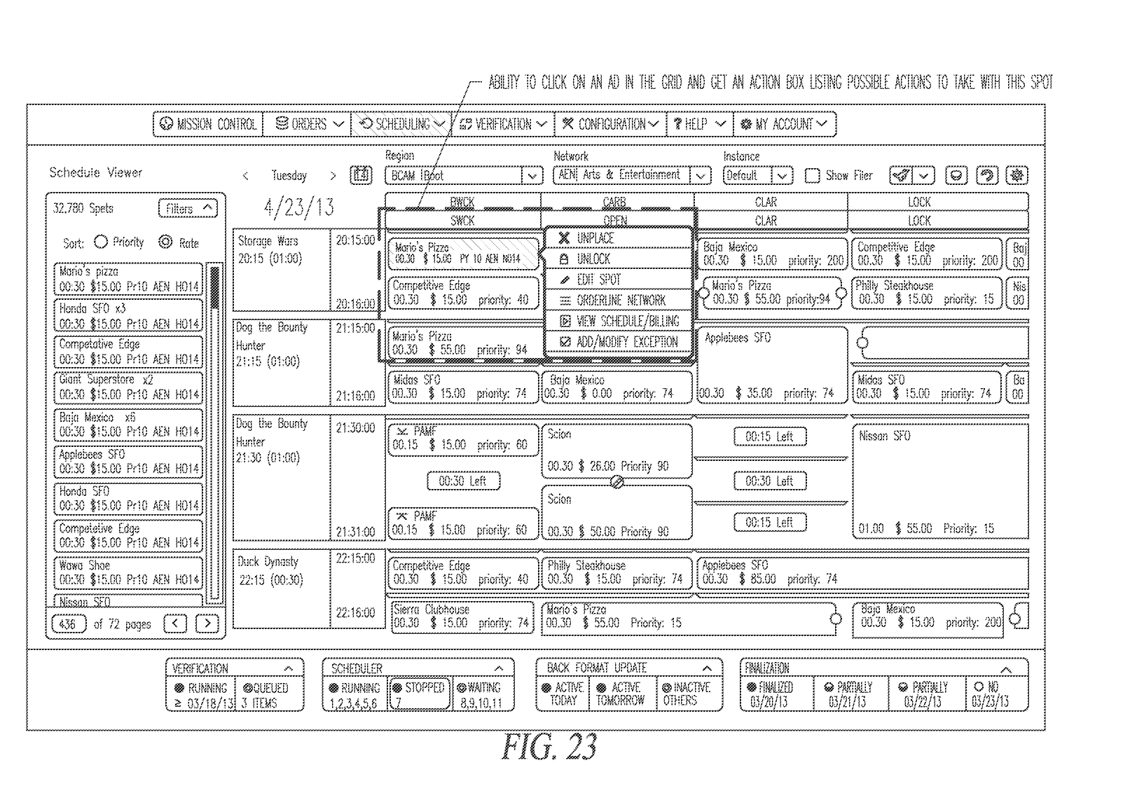

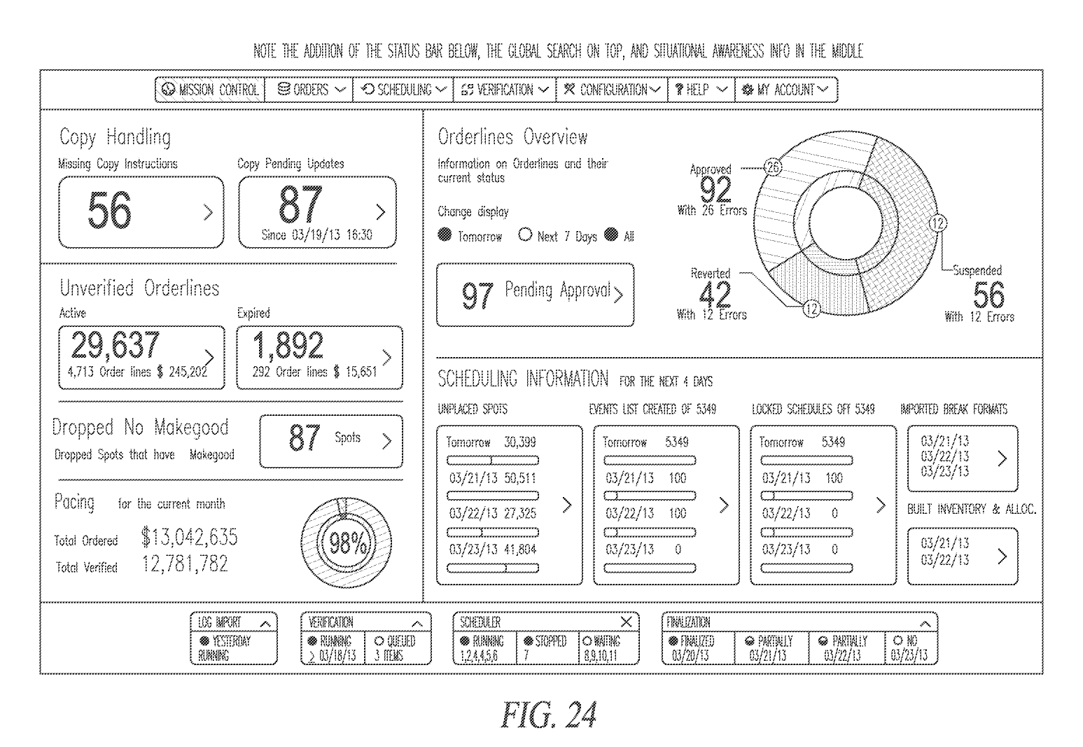

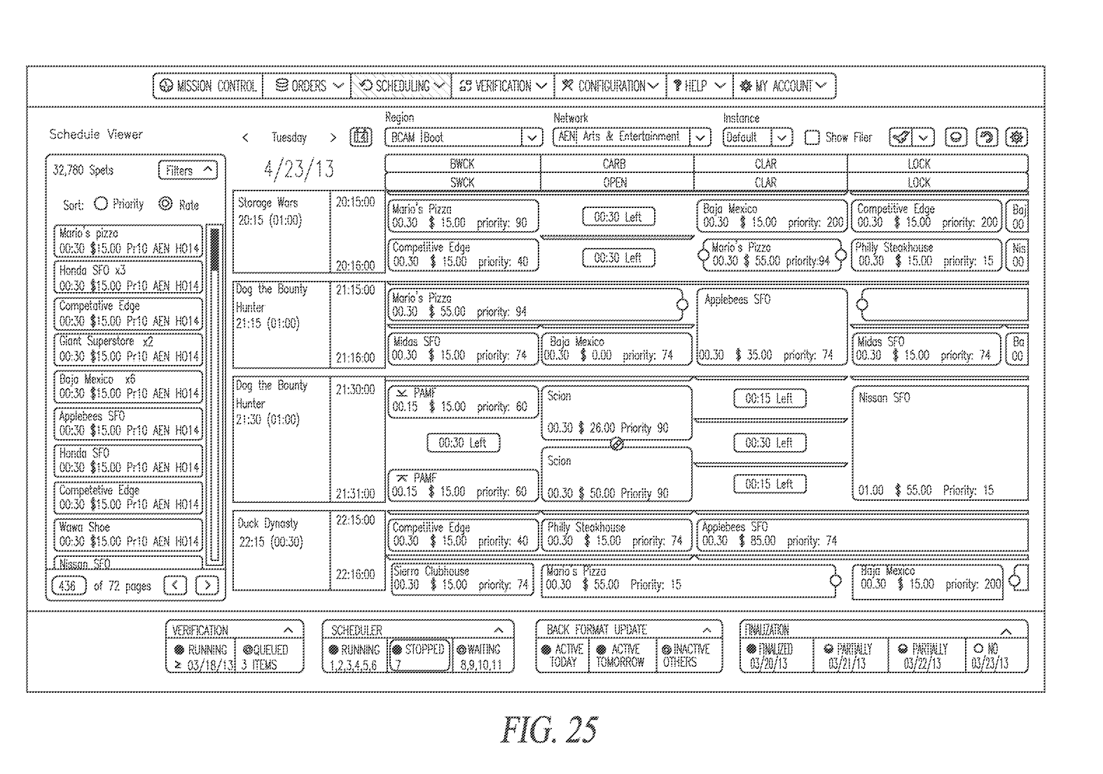

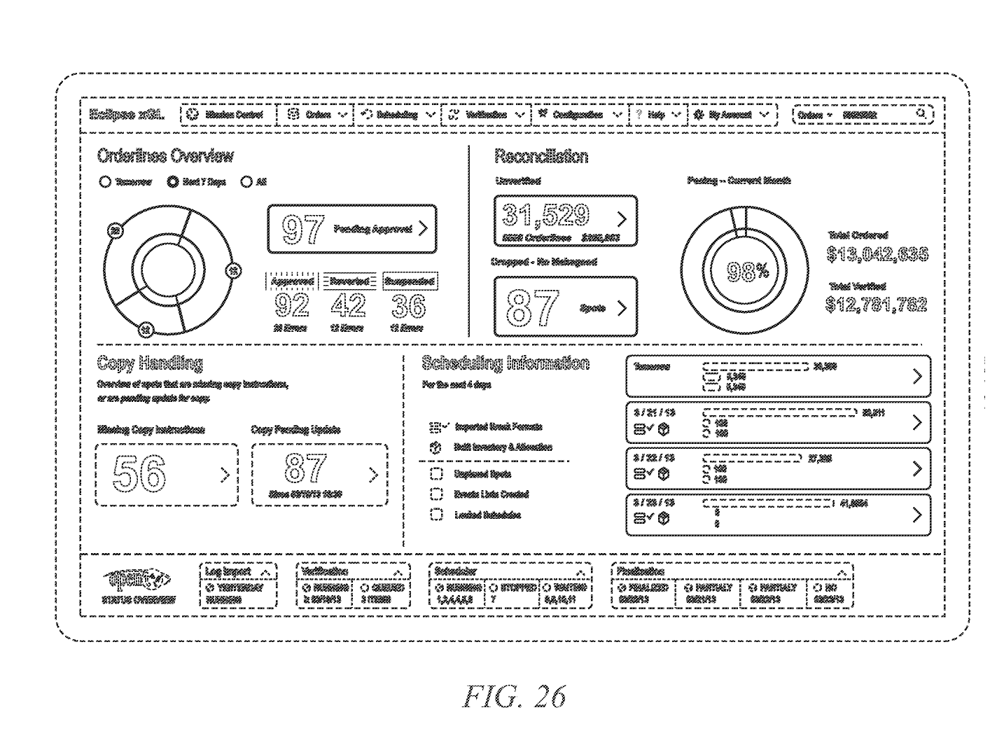

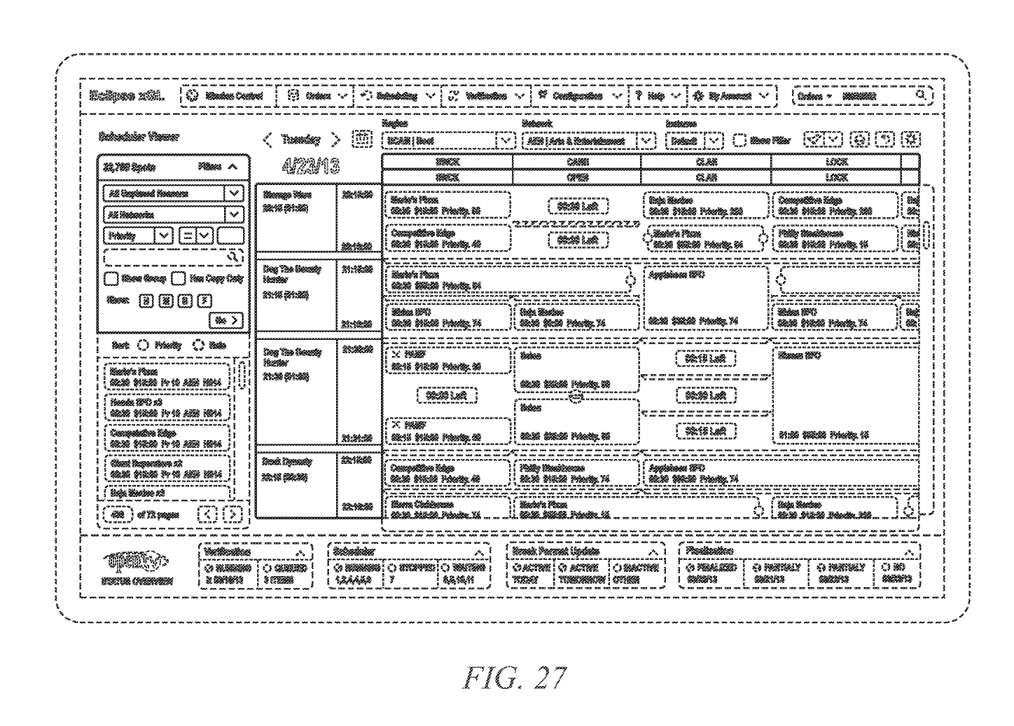

FIGS. 2-27 are slides that collectively illustrate and discuss example embodiments of various screens (e.g., graphical windows) that are presentable as part of the graphical user interface provided by the ad scheduling machine 110.

A “mission control” screen may be used as a main “home” screen for the user. Different users may have different roles, and the information in the mission control screen may be role-specific. There may be a standard menu bar across the top of the screen, and it may include a quick search feature. There may be a status bar along the bottom of the screen, and it may show progress made by the system in processing specific tasks previously requested by the user.

The status bar may include a separate status box for each task or age class of tasks (e.g., tasks being performed by an automated scheduler module, or tasks performed by a verification module). Clicking on a status box may cause a pop-up window to overlay the current screen and present more detailed status information. Hence this detailed status information may be retrieved directly from the status bar.

The mission control screen may include one or more widgets (e.g., dashboard widgets) that summarize information. Clicking on a dashboard widget enables the user to obtain more detail on the summarized information. For example, a “copy handling” screen may be presented in response to a click on the corresponding widget within the mission control screen.

A “schedule viewer” screen may provide the user with a view into a scheduling process for fine-tuning the scheduling of an ad. The schedule viewer screen may implement a “select unplaced spot” feature, which may provide an easy way to identify which ads do not yet have an airtime (e.g., a timeslot) and make decisions on where to place them. In some example embodiments, an automated scheduler performs coarse scheduling of assets (e.g., ads), while the schedule viewer screen may be used to perform final fine-tuning.

The rules module 220 may be configured to access one or more scheduling rules (e.g., from the rules database 250), and the presentation module 230 may implement such scheduling rules in generating a screen (e.g., a graphical window) of the graphical user interface. Hence, any one or more of the screens of the graphical user interface may be generated and presented based on one or more of such scheduling rules. According to various example embodiments, this may have the effect of generating and presenting one or more screens in which the scheduling (e.g., placement) of an ad is constrained by such scheduling rules (e.g., business rules defined or otherwise provided by a customer for that particular ad). For example, when the user 122 interacts with such a screen, the screen may prevent the scheduling of an ad into certain timeslots forbidden by the scheduling rules for that ad. As another example, the screen may indicate (e.g., by graying out) one or more disallowed or otherwise unavailable timeslots for that ad. As a further example, the screen may highlight (e.g., as an indicator of encouragement) one or more customer-specified (e.g., customer-preferred) timeslots that are indicated by the scheduling rules for that ad.

Accordingly, one or more scheduling rules may be used to take into account multiple parameters to calculate priority in scheduling an ad, and these scheduling rules may be configured by an advertiser (e.g., an advertising customer that purchased an ad to be scheduled). These scheduling rules may indicate, specify, or define, for example, a value placed on particular ad (e.g., revenue expected from the running of the ad), a value of a relationship with the advertiser (e.g., total revenue for a single ad campaign that includes multiple placements of an ad), a value of a total ad relationship with the advertiser in a particular period of time (e.g., total revenue for multiple ad campaigns that include multiple placement of multiple ads within the current calendar year), a value of aggregated business done with the advertiser or an ad agency, a previous success rate at placing advertisements for the advertiser, or any suitable combination thereof. In other words, one or more scheduling rules may determine (e.g., calculate or weight) the priority of an ad based on certain aspects of the relationship with the advertiser (e.g., spot revenue, order revenue, customer revenue, or performance to date).

In some example embodiments, the schedule viewer screen contains a bird-shaped icon that, when clicked, presents a “birds eye mode” view of some or all of a programming schedule in which ads may be scheduled. This may have the effect of enabling a user to obtain a “zoomed out” view of the programming schedule, without leaving the context of the schedule viewer screen.

In certain example embodiments, the schedule viewer screen represents an individual ad as a box that, when clicked (e.g., left click or primary click), presents additional information (e.g., “spot details”) about that ad. According to some example embodiments, a different type of click (e.g., right-click or secondary click) on the box causes presentation of a menu of tasks that may be performed for that ad (e.g., unplace ad, lock ad, unlock ad, edit spot, orderline networks, view schedule, view billing, add an exception to a rule for that ad, or modify an exception to a rule for that ad).

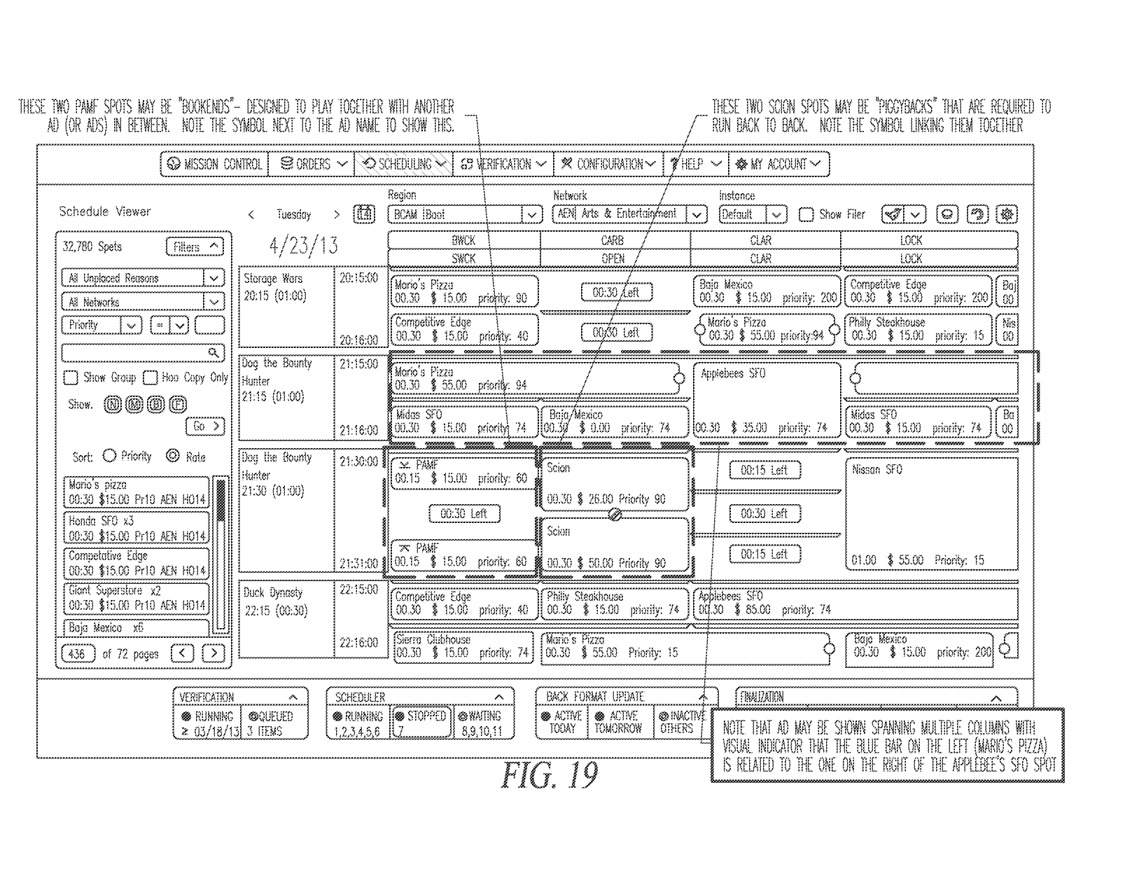

Screens (e.g., graphical windows) shown in FIGS. 19-27 illustrate example embodiments of a method to select an ad from a list of unplaced ads, in preparation for subsequently dragging and dropping it into a schedule grid. In some situations, the user 122 is not allowed to drop the ad into just any spot. For example, an unplaced ad might only be placeable into a position that is consistent with applicable business rules related to the ad, the position, or both. In some example embodiments, the challenge for the user is knowing which position the unplaced ad is compatible with. “Compatibility” here refers to being consistent with the business rules under which the customer ordered the ad.

For example, the customer may have specified that their ad must appear on a certain channel, or within a certain time window, or as the first ad of a break (or the last), etc. Also, certain slots in the schedule may be assigned to particular inventory types for ads. For example, the first ad break in a national popular show might be reserved to ads to be shown nationally, and hence an ad purchased on a regional basis would not be allowed into a national slot.

The ad scheduling machine 110 is configured to automatically highlight eligible slots in response to a user selecting an ad to place. This way, the user 122 knows where it is possible to drag the ad to be placed, before the user 122 actually performs the ad placement (e.g., using a drag-and-drop mechanism in the graphical user interface).

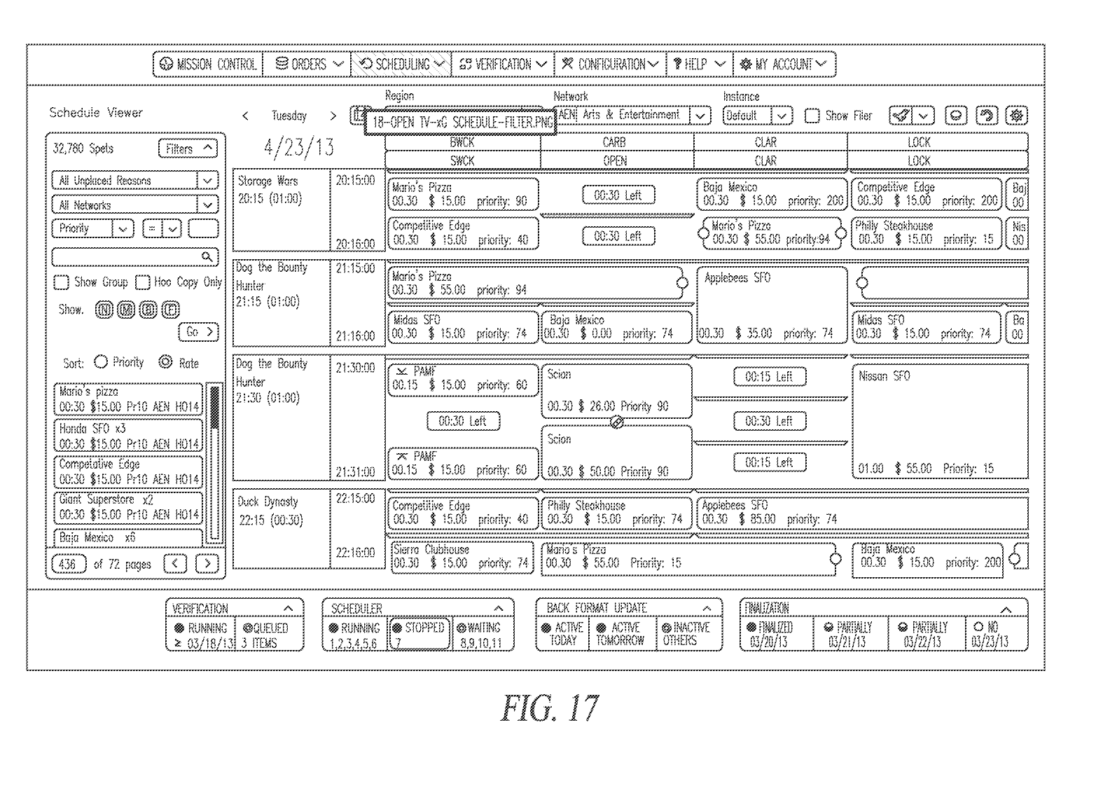

In FIG. 17 (Diagram A), a normal grid is shown, with nothing highlighted.

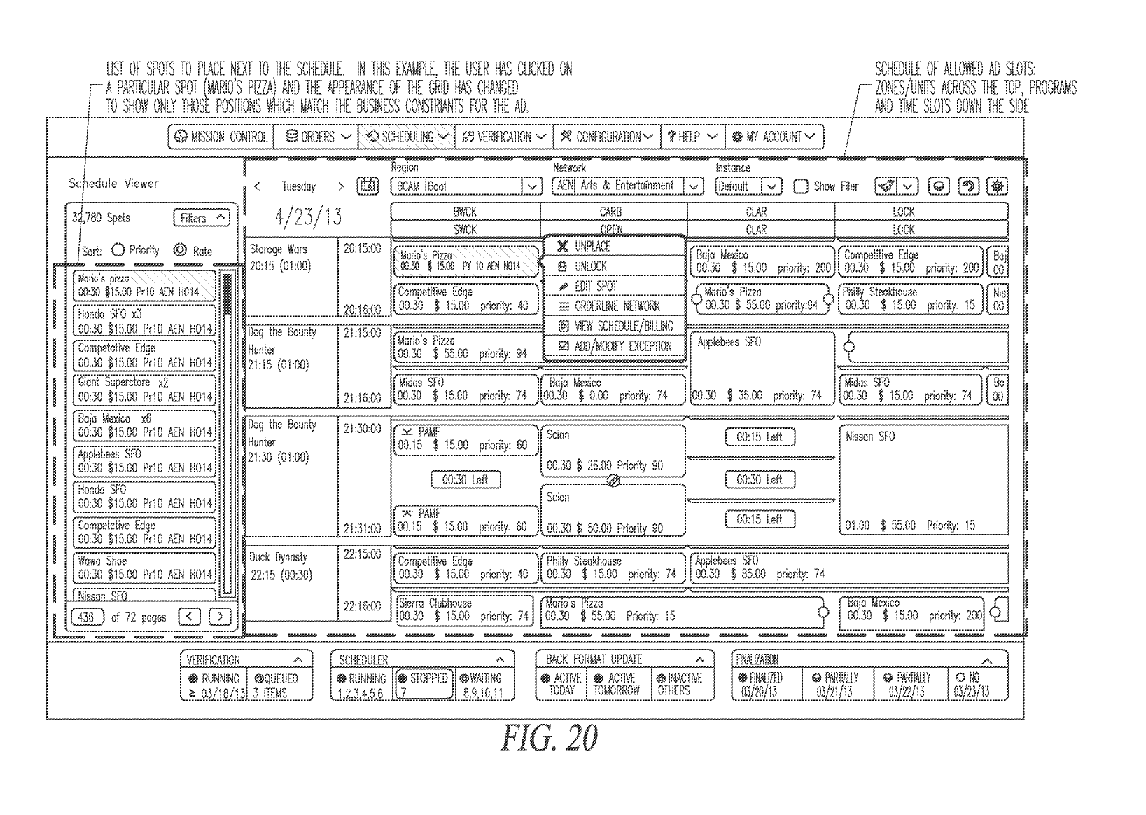

In FIG. 20 (Diagram B), there is an instance of a grid, as well as a list of unplaced spots. The selected spot is highlighted. Note that many elements in the grid may be greyed out to indicate they are not applicable to the selected spot. Because the grid may be much larger than the available screen real estate, the system may also provide a “bird's eye view” of the total grid (e.g., some or all of the entire programming schedule, which may be stored in a scheduling database).

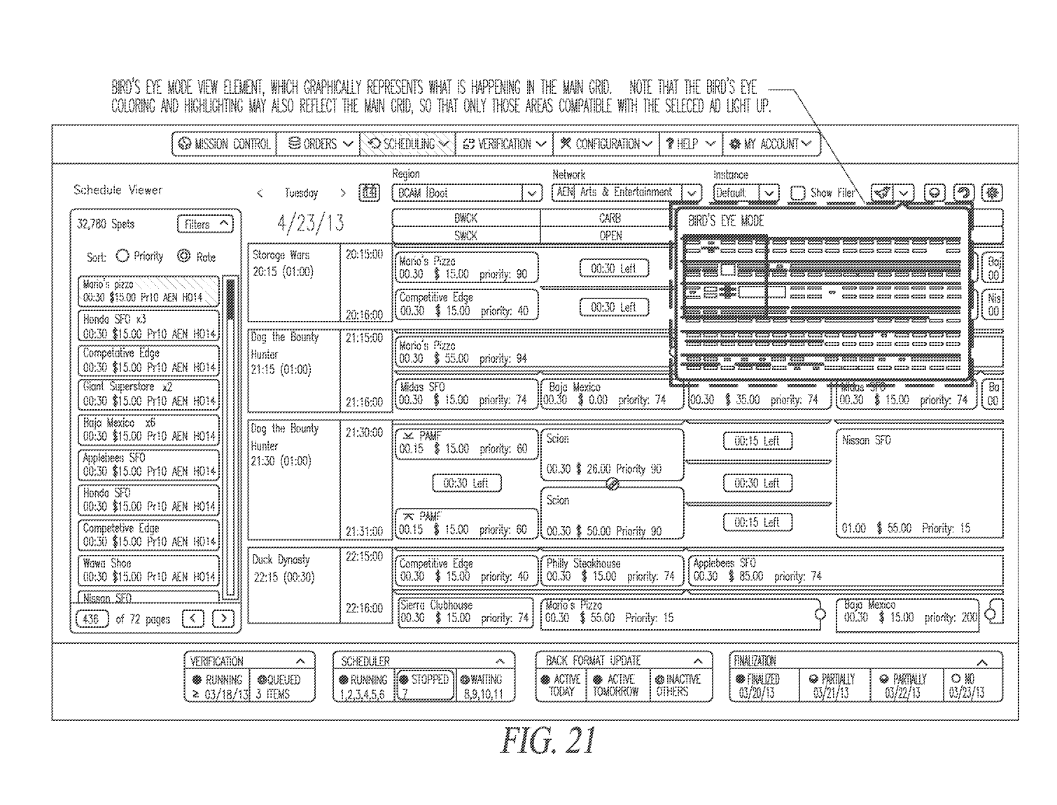

This view may be especially useful when combined with the highlighted grid method. The ad scheduling machine 110 may highlight the graphical bird's eye view in a manner similar to the main grid. See FIG. 21 (Diagram C). This may enable the user 122 to get a global view of availability, as well as with what is in the main view.

Other variations are possible. While some example embodiments of the ad scheduling machine 110 use a selected spot as a criterion for selecting what to highlight, other criteria are also usable. For example, the ad scheduling machine 110 could use a selected class of spots, or even spots with a particular parental rating, genre, etc. The ad scheduling machine 110 may present shortcut buttons to highlight comedies, news, etc.

The ad scheduling machine 110 may support multiple levels of highlighting. For example, positions that have the right genre and are compatible with the selected spot may be highlighted. Positions of the right genre but that are otherwise not compatible with the selected spot maybe greyed, while those incompatible with both genre and the selected spot may be very dark.

Also, while FIGS. 19-27 show the ad scheduling machine 110 highlighting based on a spot selected in the list to the left, the user 122 may also select a spot already in the grid to see other spot positions that are compatible. In some example embodiments, selecting a spot in the grid highlights some spots in the unplaced spot list, so the user 122 can see which spots could replace a particular one in the grid. Indeed, the “list” could be another grid, with its own bird's eye view (e.g., if the user was moving items between schedules).

A similar methodology may be applied to an electronic program guide (EPG). For example, the user 122 might highlight all programs of a certain genre in the grid, movies or shows with a certain star, director, etc.; football games; reruns; first run programs; or programs with a certain parental rating.

The bird's eye view is applicable to an EPG that a system (e.g., the ad scheduling machine 110) may present as a graphical view of a multi-day, multi-channel grid. Highlighting may be based on a program search or genre search. With multiple levels of highlighting, all sports games might be indicated, with the desired sport (e.g. football) highlighted differently.

The user selections may be inputted, received, detected, or otherwise obtained from a mouse or other pointing device, arrow keys, function keys, or any suitable combination thereof. These screens and methods may be implemented by a set-top box, where a user might use some combination of key presses to move the bird's eye boundary box around in the schedule to quickly get into the desired “neighborhood.” From there, the user 122 may toggle back into the main grid and select the specific program. Arrow key navigation could be “smart,” moving only from highlight box to highlighted box.

The highlighted grid may also be used to indicate things like programs that are currently scheduled for recording. Multiple types of highlighting might indicate who initiated the recording (e.g., which family member selected the program for recording).

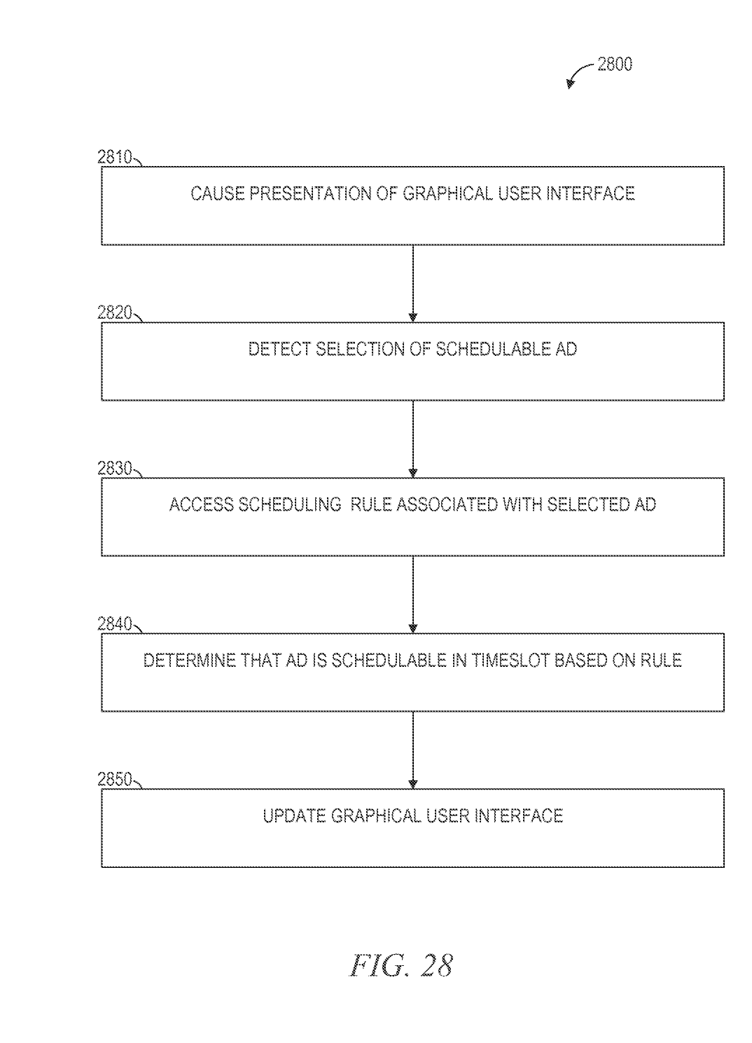

FIGS. 28-30 are flowcharts illustrating operations of the ad scheduling machine 110 in performing a method 2800 of scheduling an ad, according to some example embodiments. Operations in the method 2800 may be performed by the ad scheduling machine 110, using modules described above with respect to FIG. 1. As shown in FIG. 28, the method 2800 includes operations 2810, 2820, 2830, 2840, and 2850.

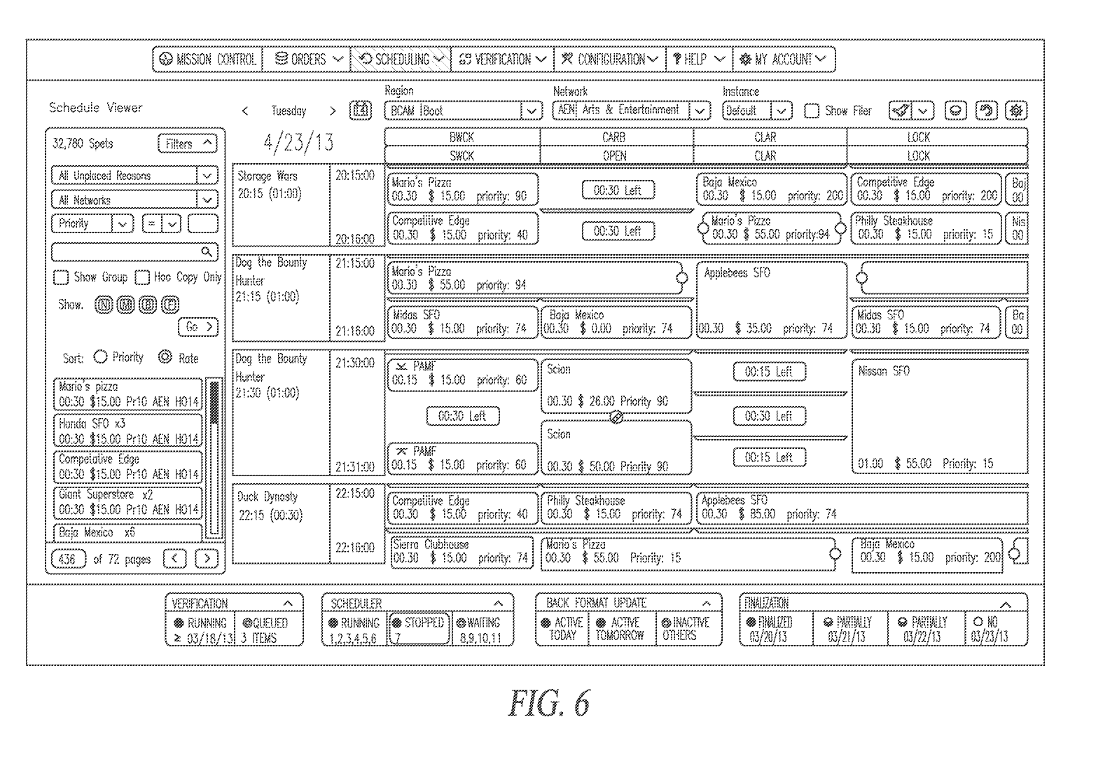

In operation 2810, the presentation module 230 causes presentation of a graphical user interface, or a screen thereof (e.g., a window of the graphical user interface), that displays a group of available timeslots that are available for scheduling ads (e.g., generally available for scheduling ads, without regard to any scheduling rules for individual ads). Examples of such a screen (e.g., a graphical window of the graphical user interface) are illustrated in FIGS. 6 and 17-19. The presentation module 230 may generate the graphical user interface (e.g., a screen thereof) based on information accessed from the scheduling database 240. As noted above, the scheduling database 240 may maintain a schedule (e.g., a programming schedule or programming grid) for ads (e.g., among other media content). The schedule may include one or more available (e.g., unused or unoccupied) timeslots in which one or more ads are able to be scheduled. Accordingly, the presentation module 230 may access the scheduling database 240, identify the timeslots that are available for scheduling ads, generate the graphical user interface (e.g., a screen thereof), and cause the graphical user interface (e.g., the screen) to be presented (e.g., by the ad scheduling machine 110, the client device 120, or any suitable combination thereof). For example, the graphical user interface (e.g., the screen) may be presented on the display 125 of the client device 120 (e.g., to the user 122 of the client device 120). Operation 2810 may include providing the graphical user interface (e.g., the screen) to the client device 120 (e.g., a display device) via the network 190, providing instructions to display the graphical user interface (e.g., the screen) to the client device 120 via the network 190, or both.

For example, the graphical user interface (e.g., the screen) whose presentation is caused in operation 2810 may be configured to display a group (e.g., a first group or a first plurality) of available timeslots that are available for scheduling ads. In various example embodiments, the graphical user interface (e.g., the screen) is further configured to display a group (e.g., a second group or a second plurality) of unavailable timeslots during which ads have already been scheduled, a group (e.g., a third group or third plurality) of schedulable ads that are available for scheduling (e.g., unscheduled ads or unplaced spots), or both.

In operation 2820, the presentation module 230 detects that an ad is selected from among a group (e.g., the third group or third plurality) of schedulable ads. The group of schedulable ads may include one or more ads that are available for scheduling (e.g., unscheduled ads or ads that are already scheduled but still available for further scheduling), that are not yet scheduled in any of the displayed group (e.g., the first group or first plurality) of available timeslots in the graphical user interface, or that are both.

In operation 2830, the rules module 220 accesses a scheduling rule that corresponds to the selected ad (e.g., a selected unscheduled ad). For example, the rules module 220 may access the scheduling rule from the rules database 250. As noted above, the rules database 250 may store rules governing individual ads (e.g., rules set by a customer for presenting the selected ad). The selected ad may have one or more of such scheduling rules stored in the rules database 250. Accordingly, the rules module 220 may access the rules database 250 and accordingly access (e.g., read or retrieve) a scheduling rule for the selected ad.

In operation 2840, the rules module 220 determines that the selected ad is schedulable in an available timeslot among the displayed group (e.g., the first group with the first plurality) of available timeslots, based on (e.g., in accordance with) the scheduling rule accessed in operation 2830. For example, the rules module 220 may determine that the selected ad is specifically schedulable only in a portion (e.g., a first portion) of the displayed group (e.g., the first group or first plurality) of available timeslots (e.g., displayed by the graphical user interface in operation 2810) and specifically not schedulable in the remainder (e.g., a second portion) of the displayed group of available timeslots, in accordance with the scheduling rule accessed in operation 2830. In some example embodiments, the rules module 220 may determine that the displayed group of available timeslots includes the portion of the group (e.g., the portion of the timeslots) in which the selected ad is specifically schedulable, as well as the remainder of the group (e.g., the remainder of the timeslots) in which the selected ad is specifically not schedulable. According to various example embodiments, performance of operation 2840 may include determining that the available timeslot satisfies the scheduling rule accessed in operation 2830.

In operation 2850, the presentation module 230 causes (e.g., update) the graphical user interface (e.g., a screen thereof) to indicate that the selected ad is specifically schedulable in the available timeslot determined in operation 2840. For example, the presentation module 230 may cause the graphical user interface to indicate that the selected ad is specifically schedulable in one or more of the available timeslots within only the portion (e.g., a first portion) of the displayed group (e.g., first group or first plurality) of available timeslots and specifically not schedulable in the remainder (e.g., a second portion) of the displayed group of timeslots. Operation 2850 may be performed based on (e.g., in response to) completion of operation 2840.

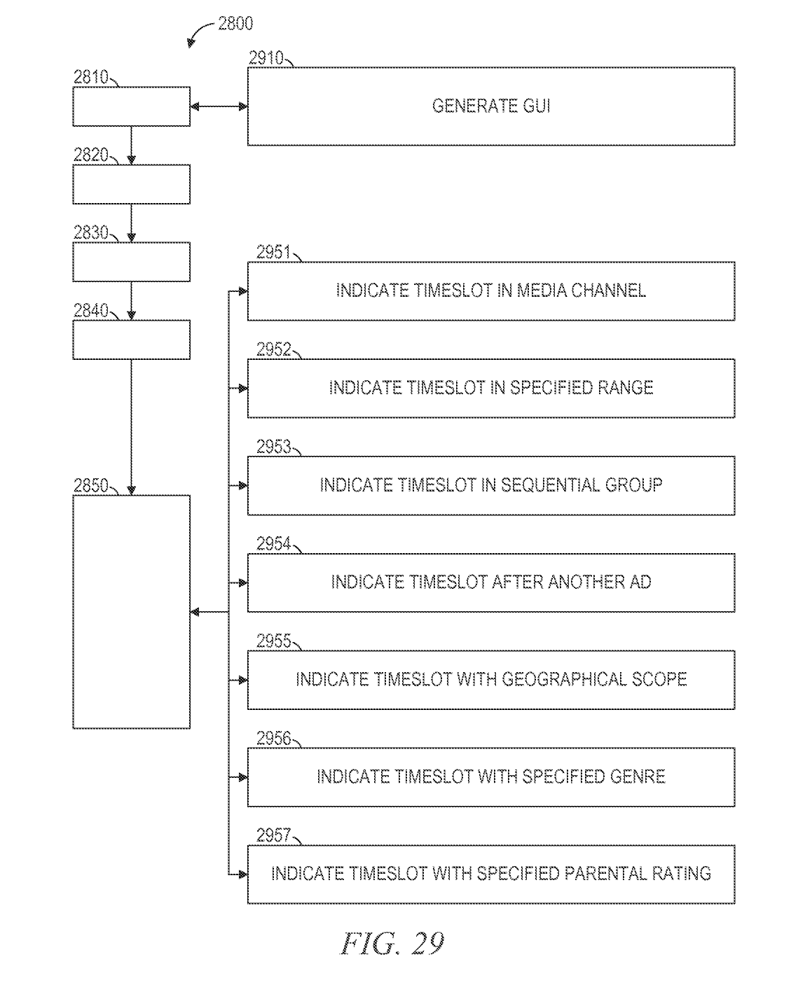

As shown in FIG. 29, the method 2800 may include one or more of operations 2910, 2951, 2952, 2953, 2954, 2955, 2956, and 2957. Operation 2910 may be performed as part (e.g., a precursor task, a subroutine, or a portion) of operation 2810, in which the presentation module 230 causes presentation of the graphical user interface (e.g., a screen of the graphical user interface) that displays the group of available timeslots that are available for scheduling ads. In operation 2910, the presentation module 230 generates the graphical user interface (e.g., a screen thereof). For example, the presentation module 230 may generate the graphical user interface (e.g., the screen) to display the group (e.g., first group or first plurality) of available timeslots discussed above with respect to operation 2810. Furthermore, the generated graphical user interface (e.g., the screen) may display a group (e.g., second group or second plurality) of unavailable timeslots during which ads have already been scheduled, a group (e.g., third group or third plurality) of schedulable ads that are available for scheduling (e.g., unscheduled ads or unplaced spots), or both.

One or more of operations 2951-2957 may be performed as part of operation 2850, in which the presentation module 230 causes the graphical user interface (e.g., a screen thereof) to indicate that the selected ad is schedulable in the available timeslot. In example embodiments that include operation 2951, the available timeslot (e.g., the determined available timeslot, as determined in operation 2840) corresponds to a channel (e.g., a first media channel) among multiple channels (e.g., a plurality of media channels for which available timeslots are displayed in the screen). Moreover, the scheduling rule accessed in operation 2830 may specify usage of the channel (e.g., the first media channel) for the selected ad. For example, the scheduling rule may specify that the selected ad be scheduled only within the specified channel. In operation 2951, the presentation module 230 causes the graphical user interface (e.g., the screen) to indicate that the selected ad is schedulable into the available timeslot (e.g., the determined available timeslot) that corresponds to the specified channel (e.g., the first media channel).

In example embodiments that include operation 2952, the available timeslot (e.g., the determined available timeslot, as determined in operation 2840) is included within a range of timeslots (e.g., first range of timeslots). Moreover, the scheduling rule accessed in operation 2830 may specify usage of the range of timeslots (e.g., the first range of timeslots) for the selected ad. For example, the scheduling rule may specify that the selected ad be scheduled only within the specified range of timeslots. In operation 2952, the presentation module 230 causes the graphical user interface (e.g., the screen) to indicate that the selected ad is schedulable into the available timeslot (e.g., the determined available timeslot) within the specified range of timeslots (e.g., the first range of timeslots).

In example embodiments that include operation 2953, the available timeslot (e.g., the determined available timeslot, as determined in operation 2840) is included within a group of sequential timeslots (e.g., a first group of sequential timeslots) and has an ordinal position within the group of sequential timeslots. Each sequential timeslot in the group may have a different ordinal position within that group (e.g., first, second, third, penultimate, or last). Moreover, the scheduling rule accessed in operation 2830 may specify usage of the ordinal position within any group of sequential timeslots for the selected ad. For example, the scheduling rule may specify that the selected ad be scheduled only first within any group of sequential timeslots. As another example, the scheduling rule may specify that the selected ad be scheduled only last within any group of sequential timeslots. In operation 2953, the presentation module 230 causes the graphical user interface (e.g., the screen) to indicate that the selected ad is schedulable into the available timeslot (e.g., the determined available timeslot) that has the specified ordinal position (e.g., first, second, third, penultimate, or last) within the group of sequential timeslots (e.g., the first group of sequential timeslots). According to various example embodiments, the graphical user interface (e.g., the screen) may further be updated to indicate that the selected ad is not schedulable into at least one other timeslot in the group of sequential timeslots.

For example, the specified ordinal position may be “first,” and the available timeslot (e.g., the determined available timeslot) may be first among the group of sequential timeslots. Accordingly, performance of operation 2953 may cause the graphical user interface (e.g., a screen thereof) to indicate that the selected ad is schedulable in the first sequential timeslot of the group of sequential timeslots, but not schedulable in the second sequential timeslot of the group.

As another example, the specified ordinal position may be “last,” and the available timeslot (e.g., the determined available timeslot) may be last among the group of sequential timeslots. Accordingly, performance of operation 2953 may cause the graphical user interface (e.g., the screen) to indicate that the selected ad is schedulable in the last sequential timeslot of the group of sequential timeslots, but not schedulable in the penultimate (e.g., second-to-last) sequential timeslot of the group.

In example embodiments that include operation 2954, the scheduling rule accessed in operation 2830 specifies that the selected ad (e.g., a first ad) be scheduled immediately after (e.g., following) another ad (e.g., a second ad). In operation 2954, the presentation module 230 causes the graphical user interface (e.g., the screen) to indicate that the selected ad (e.g., the first ad) is schedulable in a sequential timeslot that immediately follows another timeslot in which the other ad (e.g., the second ad) is already scheduled.

In example embodiments that include operation 2955, the scheduling rule accessed in operation 2830 specifies a geographical scope (e.g., a first geographical scope) for the selected ad. Examples of a geographical scope include global, national, regional, or local. Moreover, only a portion of the displayed group (e.g., first group or first plurality) of timeslots may be available to schedule ads (e.g., any ad) for which the geographical scope (e.g., the first geographical scope) is specified, and the available timeslot (e.g., the determined available timeslot) may be included in this portion. Furthermore, the remainder of the displayed group of timeslots may be available only for ads that have a different geographical scope (e.g., a second geographical scope). In operation 2955, the presentation module 230 causes the graphical user interface (e.g., the screen) to indicate, based on the specified geographical scope, that the selected ad is schedulable in the available timeslot (e.g., the determined available timeslot) that is within the portion of the displayed group of timeslots but not schedulable in any timeslot (e.g., a second timeslot) within the remainder of the displayed group of timeslots.

In example embodiments that include operation 2956, the scheduling rule accessed in operation 2830 specifies a genre (e.g., a first genre) of media content for the selected ad. Examples of genres of media content include comedy, news, drama, action, documentary, and sports. Moreover, only a portion of the displayed group (e.g., first group or first plurality) of timeslots may be available to schedule ads (e.g., any ad) for which the genre (e.g., the first genre of media content) is specified, and the available timeslot (e.g., the determined available timeslot) may be included in this portion. Furthermore, the remainder of the displayed group of timeslots may be available only for ads that have a different genre (e.g., a second genre of media content). In operation 2956, the presentation module 230 causes the graphical user interface (e.g., the screen) to indicate, based on the specified genre, that the selected ad is schedulable in the available timeslot (e.g., the determined available timeslot) that is within the portion of the displayed group of timeslots but not schedulable in any timeslot (e.g., a second timeslot) within the remainder of the displayed group of timeslots.

In example embodiments that include operation 2957, the scheduling rule accessed in operation 2830 specifies a parental rating (e.g., a first parental rating) for media content, for the selected ad, or for both. Examples of a parental rating include “G” (e.g., general audiences), “PG” (e.g., parental guidance suggested), “PG-13” (e.g., parents strongly cautioned), “R” (e.g., restricted), and “NC-17” (e.g., no one 17 and under admitted). Moreover, only a portion of the displayed group (e.g., first group or first plurality) of timeslots may be available to schedule ads (e.g., any ad) for which the parental rating (e.g., the first parental rating) is specified, and the available timeslot (e.g., the determined available timeslot) may be included in this portion. Furthermore, the remainder of the displayed group of timeslots may be available only for ads that have a different parental rating (e.g., a second parental rating). In operation 2957, the presentation module 230 causes the graphical user interface (e.g., the screen) to indicate, based on the specified parental rating, that the selected ad is schedulable in the available timeslot (e.g., the determined available timeslot) that is within the portion of the displayed group of timeslots but not schedulable in any timeslot (e.g., a second timeslot) within the remainder of the displayed group of timeslots.

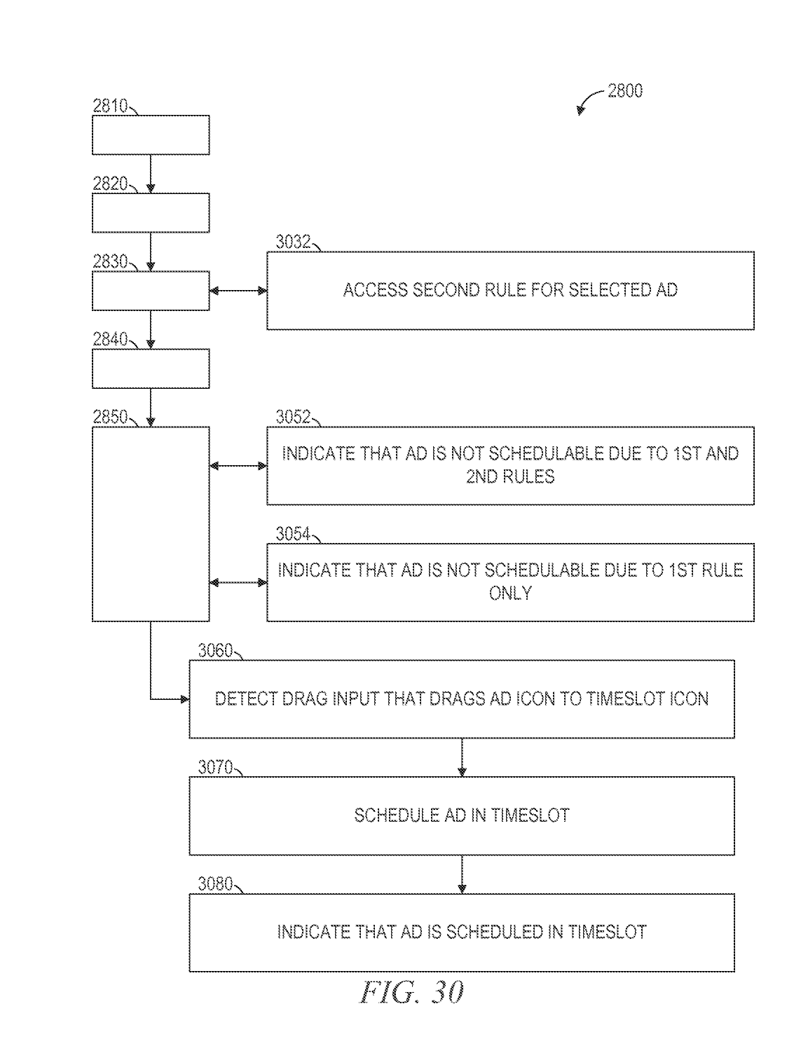

As shown in FIG. 30, the method 2800 may include one or more of operations 3032, 3052, 3054, 3060, 3070, and 3080. Operation 3032 may be performed as part of operation 2830, in which the rules module 220 accesses the scheduling rule that corresponds to the selected ad. In some situations, more than one scheduling rule corresponds to the selected ad, and the scheduling rule accessed in operation 2830 may be a first scheduling rule (e.g., among multiple scheduling rules stored by the rules database 250 for the selected ad). In operation 3032, the rules module 220 accesses a second scheduling rule that corresponds to the specified ad (e.g., from the rules database 250). Accordingly, the determination in operation 2840 that the selected ad is schedulable in the portion of the set of timeslots may be based on both the first scheduling rule and the second scheduling rule. Moreover, the effect of the first and second scheduling rules may be indicated in operation 2850 by one or more updates to the graphical user interface (e.g., one or more updates to a screen thereof).

In some situations, application of the first scheduling rule limits the displayed group (e.g., first group or first plurality) of timeslots to a first portion of the displayed group, while application of the second scheduling rule limits the displayed group of timeslots to a second portion of the displayed group. In such situations, the intersection of the first and second portions of the display group constitutes a third portion of the displayed group of timeslots.

In some example embodiments, operation 3052 may be performed as part of operation 2850. In operation 3052, the presentation module 230 causes the graphical user interface (e.g., a screen thereof) to indicate that the selected ad is schedulable in the third portion (e.g., the intersection of the first and second portions) of the display group of timeslots, but not schedulable in the remainder of the display group of timeslots, due to the combined application of the first and second scheduling rules. For example, schedulable timeslots that satisfy both scheduling rules may be displayed normally (e.g., without any graying or darkening); non-schedulable timeslots that satisfy only one scheduling rule may be lightly grayed out; and non-schedulable timeslots that satisfy no scheduling rules may be darkly grayed out or blacked out.

In alternative example embodiments, operation 3054 may be performed as part of operation 2850. In operation 3054, the presentation module 230 causes the graphical user interface (e.g., the screen) to indicate that the selected ad is schedulable in the first portion, in its entirety, due to application of the first scheduling rule (e.g., only) and despite application of the second scheduling rule. For example, schedulable timeslots that satisfy both scheduling rules may be displayed normally (e.g., without any graying or darkening); schedulable timeslots that satisfy only the first scheduling rule may be displayed normally or may be lightly grayed out and yet still available for scheduling the selected ad; and non-schedulable timeslots that do not satisfy the first scheduling rule may be grayed out or blacked out.

One or more of operations 3060, 3070, and 3080 may be performed after operation 2850, in which the presentation module 230 causes the graphical user interface (e.g., a screen thereof) to indicate that the selected ad is schedulable in the available timeslot (e.g., the determined available timeslot, as determined in operation 2840). In operation 3060, the presentation module 230 detects selection of the available timeslot (e.g., the determined available timeslot). In some example embodiments, performance of operation 3060 includes detecting that the available timeslot has been selected (e.g., by the user 122) for scheduling the selected ad. For example, the presentation module 230 may detect that a drag input received by the client device 120 (e.g., via the display 125) has dragged a first icon to a second icon. In particular, the first icon may represent the selected ad (e.g., on the display 125), and the second icon may represent the available timeslot (e.g., on the display 125). This may have the effect of enabling the user 122 to assign the selected ad to the available timeslot, which may constitute a request or command to schedule the selected ad into the available timeslot.

In operation 3070, the scheduling module 210 fulfills such a request or command to schedule the selected ad (e.g., a selected unscheduled ad) into the available timeslot (e.g., the determined available timeslot). The scheduling module 210 may accordingly update the scheduling database 240 to indicate that the available timeslot (e.g., designated by the user 122) corresponds to the selected ad, or vice versa. Operation 3070 may be performed in response to operation 3260.

In operation 3080, presentation module 230 updates the graphical user interface (e.g., a screen thereof) to indicate that the selected ad (e.g., the selected unscheduled ad) has been scheduled in the available timeslot (e.g., the determined available timeslot). Operation 3080 may be performed in response to operation 3070. In some example embodiments, operation 3080 may be performed by displaying the selected ad in the available timeslot. For example, the selected ad may be displayed as occupying the available timeslot or being otherwise assigned to (e.g., mapped to or correlated with) the available timeslot. In certain example embodiments, operation 3080 includes causing the graphical user interface (e.g., the screen) to indicate that the available timeslot is unavailable (e.g., no longer available, due to the scheduling of the selected ad into the available timeslot).

According to various example embodiments, one or more of the methodologies described herein may facilitate scheduling one or more ads. Moreover, one or more of the methodologies described herein may facilitate simplification of user workflows, increases in user productivity, implementation of a “push” model for scheduling rules that govern ad scheduling, reduction of steps (e.g., clicks) used to complete ad scheduling tasks, provision of status information, or any suitable combination thereof.

When these effects are considered in aggregate, one or more of the methodologies described herein may obviate a need for certain efforts or resources that otherwise would be involved in scheduling ads. Efforts expended by a user in scheduling ads may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 31 is a block diagram illustrating components of a machine 3100, according to some example embodiments, able to read instructions 3124 from a machine-readable medium 3122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 31 shows the machine 3100 in the example form of a computer system (e.g., a computer) within which the instructions 3124 (e.g., software, a program, an application, an applet, an app, or other executable code) for causing the machine 3100 to perform any one or more of the methodologies discussed herein may be executed, in whole or in part.

In alternative embodiments, the machine 3100 operates as a standalone device or may be connected (e.g., networked) to other machines. In a networked deployment, the machine 3100 may operate in the capacity of a server machine or a client machine in a server-client network environment, or as a peer machine in a distributed (e.g., peer-to-peer) network environment. The machine 3100 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 3124, sequentially or otherwise, that specify actions to be taken by that machine. Further, while only a single machine is illustrated, the term “machine” shall also be taken to include any collection of machines that individually or jointly execute the instructions 3124 to perform all or part of any one or more of the methodologies discussed herein.

The machine 3100 includes a processor 3102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 3104, and a static memory 3106, which are configured to communicate with each other via a bus 3108. The processor 3102 may contain microcircuits that are configurable, temporarily or permanently, by some or all of the instructions 3124 such that the processor 3102 is configurable to perform any one or more of the methodologies described herein, in whole or in part. For example, a set of one or more microcircuits of the processor 3102 may be configurable to execute one or more modules (e.g., software modules) described herein.

The machine 3100 may further include a graphics display 3110 (e.g., a plasma display panel (PDP), a light emitting diode (LED) display, a liquid crystal display (LCD), a projector, a cathode ray tube (CRT), or any other display capable of displaying graphics or video). The machine 3100 may also include an alphanumeric input device 3112 (e.g., a keyboard or keypad), a cursor control device 3114 (e.g., a mouse, a touchpad, a trackball, a joystick, a motion sensor, an eye tracking device, or other pointing instrument), a storage unit 3116, an audio generation device 3118 (e.g., a sound card, an amplifier, a speaker, a headphone jack, or any suitable combination thereof), and a network interface device 3120.

The storage unit 3116 includes the machine-readable medium 3122 (e.g., a tangible and non-transitory machine-readable storage medium) on which are stored the instructions 3124 embodying any one or more of the methodologies or functions described herein. The instructions 3124 may also reside, completely or at least partially, within the main memory 3104, within the processor 3102 (e.g., within the processor's cache memory), or both, before or during execution thereof by the machine 3100. Accordingly, the main memory 3104 and the processor 3102 may be considered machine-readable media (e.g., tangible and non-transitory machine-readable media). The instructions 3124 may be transmitted or received over the network 190 via the network interface device 3120. For example, the network interface device 3120 may communicate the instructions 3124 using any one or more transfer protocols (e.g., hypertext transfer protocol (HTTP)).

In some example embodiments, the machine 3100 may be a portable computing device, such as a smart phone or tablet computer, and have one or more additional input components 3130 (e.g., sensors or gauges). Examples of such input components 3130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 3122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 3124 for execution by the machine 3100, such that the instructions 3124, when executed by one or more processors of the machine 3100 (e.g., processor 3102), cause the machine 3100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein.

In a first example embodiment, a method is defined by at least the following operations:

causing presentation of a graphical user interface (GUI) on a display device, the GUI being configured to display a first plurality of available timeslots available for scheduling advertisements, a second plurality of unavailable timeslots during which advertisements have been scheduled, and a third plurality of unscheduled advertisements available for scheduling;
detecting selection of an unscheduled advertisement from the third plurality of unscheduled advertisements;
accessing a scheduling rule associated with the selected unscheduled advertisement;
using a processor, determining that the selected unscheduled advertisement is schedulable in a determined available timeslot among the first plurality of available timeslots in accordance with the scheduling rule; and
updating the GUI to indicate that the determined available timeslot is unavailable and display the selected unscheduled advertisement in the determined available timeslot.

In a second example embodiment, the method of the preceding description is further defined by including the following additional feature:

the determining that the selected unscheduled advertisement is schedulable in the determined available timeslot includes determining that the available timeslot satisfies the scheduling rule associated with the selected unscheduled advertisement.

In a third example embodiment, the method of any of the above descriptions is further defined by including the following additional features:

detecting selection of the determined available timeslot among the first plurality of available timeslots; and
the updating of the GUI is in response to the detected selection of the determined available timeslot.

In a fourth example embodiment, the method of any of the above descriptions is further defined by including the following additional feature:

in response to the detected selection of the determined available timeslot, scheduling the selected unscheduled advertisement into the determined available timeslot by updating a scheduling database to indicate that the determined available timeslot corresponds to the selected unscheduled advertisement.

In a fifth example embodiment, the method of the above description is further defined by including the following additional feature:

the detecting of the selection includes detecting that a drag input dragged a first icon that represents the selected unscheduled advertisement to a second icon that represents the determined available timeslot.

In a sixth example embodiment, the method of any of the above descriptions is further defined by including the following additional operation:

causing the GUI to indicate that only a portion of the first plurality of available timeslots satisfies the accessed scheduling rule associated with the selected unscheduled advertisement.

In a seventh example embodiment, the method of any of the above descriptions is further defined by including the following additional operation:

causing the GUI to indicate that a portion of the first plurality of available timeslots fails to satisfy the accessed scheduling rule associated with the selected unscheduled advertisement.

In an eighth example embodiment, the method of any of the above descriptions is further defined by including the following additional features:

the determined available timeslot corresponds to a media channel among a plurality of media channels;
the accessed scheduling rule specifies usage of the media channel for the selected unscheduled advertisement; and the method further includes
causing the GUI to indicate that the selected unscheduled advertisement is schedulable into the determined available timeslot that corresponds to the media channel whose usage is specified by the accessed scheduling rule for the selected unscheduled advertisement.

In a ninth example embodiment, the method of any of the above descriptions is further defined by including the following additional features:

the determined available timeslot is within a range of timeslots;
the accessed scheduling rule specifies usage of the range of timeslots for the selected unscheduled advertisement; and the method further includes
causing the GUI to indicate that the selected unscheduled advertisement is schedulable within the range whose usage is specified by the accessed scheduling rule for the selected unscheduled advertisement.

In a tenth example embodiment, the method of any of the above descriptions is further defined by including the following additional features:

the determined available timeslot has an ordinal position within a group of sequential timeslots that each have a different ordinal position within the group;
the accessed scheduling rule specifies usage of the ordinal position within any group of sequential timeslots for the selected unscheduled advertisement; and the method further includes
causing the GUI to indicate that selected unscheduled advertisement is schedulable into the determined available timeslot that has the ordinal position whose usage is specified by the accessed scheduling rule for the selected unscheduled advertisement.

In an eleventh example embodiment, the method of the above description is further defined by including the following additional features:

the accessed scheduling rule specifies that the selected unscheduled advertisement be scheduled first within any group of sequential timeslots; and
the updated GUI indicates that the determined available timeslot is a first sequential timeslot in the group of sequential timeslots.

In a twelfth example embodiment, the method of the tenth example embodiment is further defined by including the following additional features:

the accessed scheduling rule specifies that the selected unscheduled advertisement be scheduled last within any group of sequential timeslots; and
the updated GUI indicates that the determined available timeslot is a last sequential timeslot in the group of sequential timeslots.

In the thirteenth example embodiment, the method of the tenth example embodiments further defined by including the following additional features:

the accessed scheduling rule specifies that the selected unscheduled advertisement be scheduled immediately after a different advertisement; and
the updated GUI indicates that the determined available timeslot is a sequential timeslot that immediately follows a different timeslot in which the different advertisement is scheduled.

In a fourteenth example embodiment, a system includes at least the following components:

a presentation module configured to:
cause presentation of a graphical user interface (GUI) on a display device, the GUI being configured to display a first plurality of available timeslots available for scheduling advertisements, a second plurality of unavailable timeslots during which advertisements have been scheduled, and a third plurality of unscheduled advertisements available for scheduling; and
detect selection of an unscheduled advertisement from the third plurality of unscheduled advertisements;
   a processor configured by a rules module to:
access a scheduling rule associated with the selected unscheduled advertisement; and
determine that the selected unscheduled advertisement is schedulable in a determined available timeslot among the first plurality of available timeslots in accordance with the scheduling rule; and
   the presentation module is configured to update the GUI to indicate that the determined available timeslot is unavailable and display the selected unscheduled advertisement in the determined available timeslot.

In a fifteenth example embodiment, the system of the fourteenth example embodiment is further defined by the following features:

the accessed scheduling rule specifies a first geographical scope for the selected unscheduled advertisement; and
the presentation module is further configured to cause the GUI to indicate that the determined available timeslot is available to schedule any advertisement for which the first geographical scope is specified.

In a sixteenth example embodiment, the system of the fourteenth example embodiment is further defined by the following features:

the determined available timeslot is adjacent to scheduled media content that has a first genre;
the accessed scheduling rule specifies the first genre for the selected unscheduled advertisement; and
the presentation module is further configured to cause the GUI to indicate that the determined available timeslot is available to schedule any advertisement for which the first genre is specified.

In a seventeenth example embodiment, the system of the fourteenth example embodiment is further defined by the following features:

the determined available timeslot is adjacent to scheduled media content that has a first parental rating;
the accessed scheduling rule specifies the first parental rating for the selected unscheduled advertisement; and
the presentation module is further configured to cause the GUI to indicate that the determined available timeslot is available to schedule any advertisement for which the first parental rating is specified.

In an eighteenth example embodiment, the system of the fourteenth example embodiment is further defined by the following feature:

the scheduling rule is a business rule that corresponds to the selected unscheduled advertisement.

In a nineteenth example embodiment, a non-transitory machine-readable storage medium is defined by inclusion of instructions that, when executed by one or more processors of a machine, cause the machine to perform operations that include:

causing presentation of a graphical user interface (GUI) on a display device, the GUI being configured to display a first plurality of available timeslots available for scheduling advertisements, a second plurality of unavailable timeslots during which advertisements have been scheduled, and a third plurality of unscheduled advertisements available for scheduling;
detecting selection of an unscheduled advertisement from the third plurality of unscheduled advertisements;
accessing a scheduling rule associated with the selected unscheduled advertisement;
determining that the selected unscheduled advertisement is schedulable in a determined available timeslot among the first plurality of available timeslots in accordance with the scheduling rule; and
updating the GUI to indicate that the determined available timeslot is unavailable and display the selected unscheduled advertisement in the determined available timeslot.

In a twentieth example embodiment, the non-transitory machine-readable storage medium of the nineteenth example embodiment is further defined by inclusion of the following operation in the operations:

causing the GUI to indicate that only a portion of the first plurality of available timeslots satisfies the accessed scheduling rule associated with the selected unscheduled advertisement.

What is claimed is:

1. A method comprising:
causing presentation of a graphical user interface (GUI) on a display device, the GUI being configured to display a first plurality of available timeslots available for scheduling advertisements, a second plurality of unavailable timeslots during which advertisements have been scheduled, and a third plurality of unscheduled advertisements available for scheduling;
detecting selection of an unscheduled advertisement from the third plurality of unscheduled advertisements;
accessing a scheduling rule associated with the selected unscheduled advertisement;
using a processor, determining that the selected unscheduled advertisement is schedulable in a determined available timeslot among the first plurality of available timeslots in accordance with the scheduling rule; and
updating the GUI to indicate that the determined available timeslot is unavailable and display the selected unscheduled advertisement in the determined available timeslot.

2. The method of claim 1, wherein:
the determining that the selected unscheduled advertisement is schedulable in the determined available timeslot includes determining that the available timeslot satisfies the scheduling rule associated with the selected unscheduled advertisement.

3. The method of claim 1 further comprising:
detecting selection of the determined available timeslot among the first plurality of available timeslots; and wherein
the updating of the GUI is in response to the detected selection of the determined available timeslot.

4. The method of claim 3 further comprising:
in response to the detected selection of the determined available timeslot, scheduling the selected unscheduled advertisement into the determined available timeslot by updating a scheduling database to indicate that the determined available timeslot corresponds to the selected unscheduled advertisement.

5. The method of claim 3, wherein:
the detecting of the selection includes detecting that a drag input dragged a first icon that represents the selected unscheduled advertisement to a second icon that represents the determined available timeslot.

6. The method of claim 1 further comprising:
causing the GUI to indicate that only a portion of the first plurality of available timeslots satisfies the accessed scheduling rule associated with the selected unscheduled advertisement.

7. The method of claim 1 further comprising:
causing the GUI to indicate that a portion of the first plurality of available timeslots fails to satisfy the accessed scheduling rule associated with the selected unscheduled advertisement.

8. The method of claim 1, wherein:
the determined available timeslot corresponds to a media channel among a plurality of media channels;
the accessed scheduling rule specifies usage of the media channel for the selected unscheduled advertisement; and the method further comprises
causing the GUI to indicate that the selected unscheduled advertisement is schedulable into the determined available timeslot that corresponds to the media channel whose usage is specified by the accessed scheduling rule for the selected unscheduled advertisement.

9. The method of claim 1, wherein:
the determined available timeslot is within a range of timeslots;
the accessed scheduling rule specifies usage of the range of timeslots for the selected unscheduled advertisement; and the method further comprises
causing the GUI to indicate that the selected unscheduled advertisement is schedulable within the range whose usage is specified by the accessed scheduling rule for the selected unscheduled advertisement.

10. The method of claim 1, wherein:
the determined available timeslot has an ordinal position within a group of sequential timeslots that each have a different ordinal position within the group;
the accessed scheduling rule specifies usage of the ordinal position within any group of sequential timeslots for the selected unscheduled advertisement; and the method further comprises
causing the GUI to indicate that selected unscheduled advertisement is schedulable into the determined available timeslot that has the ordinal position whose usage is specified by the accessed scheduling rule for the selected unscheduled advertisement.

11. The method of claim 10, wherein:
the accessed scheduling rule specifies that the selected unscheduled advertisement be scheduled first within any group of sequential timeslots; and
the updated GUI indicates that the determined available timeslot is a first sequential timeslot in the group of sequential timeslots.

12. The method of claim 10, wherein:
the accessed scheduling rule specifies that the selected unscheduled advertisement be scheduled last within any group of sequential timeslots; and
the updated GUI indicates that the determined available timeslot is a last sequential timeslot in the group of sequential timeslots.

13. The method of claim 10, wherein:
the accessed scheduling rule specifies that the selected unscheduled advertisement be scheduled immediately after a different advertisement; and
the updated GUI indicates that the determined available timeslot is a sequential timeslot that immediately follows a different timeslot in which the different advertisement is scheduled.

14. A system comprising:
a presentation module configured to:
cause presentation of a graphical user interface (GUI) on a display device, the GUI being configured to display a first plurality of available timeslots available for scheduling advertisements, a second plurality of unavailable timeslots during which advertisements have been scheduled, and a third plurality of unscheduled advertisements available for scheduling; and
detect selection of an unscheduled advertisement from the third plurality of unscheduled advertisements;
a processor configured by a rules module to:
access a scheduling rule associated with the selected unscheduled advertisement; and
determine that the selected unscheduled advertisement is schedulable in a determined available timeslot among the first plurality of available timeslots in accordance with the scheduling rule; wherein
the presentation module is configured to update the GUI to indicate that the determined available timeslot is unavailable and display the selected unscheduled advertisement in the determined available timeslot.

15. The system of claim 14, wherein:
the accessed scheduling rule specifies a first geographical scope for the selected unscheduled advertisement; and
the presentation module is further configured to cause the GUI to indicate that the determined available timeslot is available to schedule any advertisement for which the first geographical scope is specified.

16. The system of claim 14, wherein:
the determined available timeslot is adjacent to scheduled media content that has a first genre;
the accessed scheduling rule specifies the first genre for the selected unscheduled advertisement; and
the presentation module is further configured to cause the GUI to indicate that the determined available timeslot is available to schedule any advertisement for which the first genre is specified.

17. The system of claim 14, wherein:
the determined available timeslot is adjacent to scheduled media content that has a first parental rating;
the accessed scheduling rule specifies the first parental rating for the selected unscheduled advertisement; and
the presentation module is further configured to cause the GUI to indicate that the determined available timeslot is available to schedule any advertisement for which the first parental rating is specified.

18. The system of claim 14, wherein:
the scheduling rule is a business rule that corresponds to the selected unscheduled advertisement.

19. A non-transitory machine-readable storage medium comprising instructions that, when executed by one or more processors of a machine, cause the machine to perform operations comprising:
causing presentation of a graphical user interface (GUI) on a display device, the GUI being configured to display a first plurality of available timeslots available for scheduling advertisements, a second plurality of unavailable timeslots during which advertisements have been scheduled, and a third plurality of unscheduled advertisements available for scheduling;
detecting selection of an unscheduled advertisement from the third plurality of unscheduled advertisements;
accessing a scheduling rule associated with the selected unscheduled advertisement;
determining that the selected unscheduled advertisement is schedulable in a determined available timeslot among the first plurality of available timeslots in accordance with the scheduling rule; and
updating the GUI to indicate that the determined available timeslot is unavailable and display the selected unscheduled advertisement in the determined available timeslot.

20. The non-transitory machine-readable storage medium of claim 19, wherein the operations further comprise:
causing the GUI to indicate that only a portion of the first plurality of available timeslots satisfies the accessed scheduling rule associated with the selected unscheduled advertisement.
